(19) United States
(12) Patent Application Publication
(10) Pub. No.: US 2026/0082386 A1
(43) Pub. Date: Mar. 19, 2026

(54) PUSCH TRANSMISSION FOR PARTIAL COHERENT UE WITH EIGHT ANTENNA PORTS

(71) Applicant: LENOVO (BEIJING) LTD., Beijing (CN)

(72) Inventors: Bingchao Liu, Beijing (CN); Chenxi Zhu, Fairfax, VA (US); Lingling Xiao, Beijing (CN); Yi Zhang, Beijing (CN); Wei Ling, Beijing (CN)

(73) Assignee: Lenovo (Beijing) Limited, Beijing (CN)

(21) Appl. No.: 19/110,685

(22) PCT Filed: Sep. 29, 2022
(86) PCT No.: PCT/CN2022/122902

§ 371 Date: Mar. 11, 2025

(51) Int. Cl. H04W 72/1268

(52) U.S. Cl. CPC H04W 72/1268

(57) ABSTRACT

Methods and apparatuses for PUSCH transmission for partial coherent UE with 8 antenna ports are disclosed. In one embodiment, a UE comprises a transceiver and a processor coupled to the transceiver, wherein the processor is configured to receive, via the transceiver, a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determine the precoding matrix for the scheduled PUSCH according to the rank and the one or two precoding matrices.

### FIELD

The subject matter disclosed herein generally relates to wireless communications, and more particularly relates to methods and apparatuses for PUSCH transmission for partial coherent UE with 8 antenna ports.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), codebook (CB), non-codebook (nCB), Sounding Reference Signal (SRS), Bandwidth part (BWP), Channel State Information Reference Signal (CSI-RS), Downlink Control Information (DCI), Transmit Precoding Matrix Indicator (TPMI), transmit rank index (TRI), codeword (CW), Demodulation Reference Signal (DMRS).

PUSCH transmission with 8 antenna ports (8Tx PUSCH) shall be supported in NR Release 18 for advanced UE equipped with 8 antennas with one or multiple layers.

This disclosure targets PUSCH transmission for partial coherent UE with 8 antenna ports.

### BRIEF SUMMARY

Methods and apparatuses for PUSCH transmission for partial coherent UE with 8 antenna ports are disclosed.

In one embodiment, a UE comprises a transceiver; and a processor coupled to the transceiver, wherein the processor is configured to receive, via the transceiver, a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determine the precoding matrix for the scheduled PUSCH according to the rank and the one or two precoding matrices.

In some embodiment, the processor is further configured to report, via the transceiver, the number of antenna groups (Ng).

In some embodiment, the processor is further configured to determine the bitwidth of the TPMI field according to a maximum rank with value of 1, 4 or 8.

In some embodiment, when a rank 1, rank 2, or rank 3 PUSCH is scheduled for UE with Ng=4, the TPMI field indicates the antenna group, by the antenna ports from which each PUSCH layer is transmitted.

In some embodiment, when a rank 4, rank 5, rank 6, rank 7 or rank 8 PUSCH is scheduled for UE with Ng=4, each PUSCH layer being transmitted by antenna ports from which antenna group is predetermined. In particular, when a rank 4 PUSCH is scheduled for UE with Ng=4, a first PUSCH layer is transmitted by antenna ports from a first antenna group, a second PUSCH layer is transmitted by antenna ports from a second antenna group, a third PUSCH layer is transmitted by antenna ports from a third antenna group, and a fourth PUSCH layer is transmitted by antenna ports from a fourth antenna group; when a rank 5 PUSCH is scheduled for UE with Ng=4, a first PUSCH layer is transmitted by antenna ports from the first antenna group, a second PUSCH layer is transmitted by antenna ports from the second antenna group, a third PUSCH layer and a fourth PUSCH layer are transmitted by antenna ports from the third antenna group, and a fifth PUSCH layer is transmitted by antenna ports from the fourth antenna group; when a rank 6 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer is transmitted by antenna ports from the fourth antenna group; when a rank 7 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer and a seventh PUSCH layer are transmitted by antenna ports from the fourth antenna group; and when a rank 8 PUSCH is scheduled for UE with Ng=4, a first PUSCH layer and a second PUSCH layer are transmitted by antenna ports from the first antenna group, a third PUSCH layer and a fourth PUSCH layer are transmitted by antenna ports from the second antenna group, a fifth PUSCH layer and a sixth PUSCH layer are transmitted by antenna ports from the third antenna group, and a seventh PUSCH layer and an eighth PUSCH layer are transmitted by antenna ports from the fourth antenna group.

In some embodiment, when a rank 1 PUSCH is scheduled for UE with Ng=2, the TPMI field indicates the antenna group, by the antenna ports from which a single PUSCH layer is transmitted.

In some embodiment, when a rank 2, rank 3, rank 4, rank 5, rank 6, rank 7 or rank 8 PUSCH is scheduled for UE with Ng=2, each PUSCH layer being transmitted by antenna ports from which antenna group is predetermined. In particular, when a rank 2 PUSCH is scheduled for UE with Ng=2, a first PUSCH layer is transmitted by antenna ports from a first antenna group, and a second PUSCH layer is transmitted by antenna ports from a second antenna group; when a rank 3 PUSCH is scheduled for UE with Ng=2, a first PUSCH layer is transmitted by antenna ports from the first antenna group, and a second PUSCH layer and a third PUSCH layer are transmitted by antenna ports from the second antenna group; when a rank 4 PUSCH is scheduled for UE with Ng=2, a first PUSCH layer and a second PUSCH layer are transmitted by antenna ports from the first antenna group, and a third PUSCH layer and a fourth PUSCH layer are transmitted by antenna ports from the second antenna group; when a rank 5 PUSCH is scheduled for UE with Ng=2, a first PUSCH layer and a second PUSCH layer are transmitted by antenna ports from the first antenna group, and a third PUSCH layer, a fourth PUSCH layer and a fifth PUSCH layer are transmitted by antenna ports from the second antenna group; when a rank 6 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer and a sixth PUSCH layer are transmitted by antenna ports from the second antenna group; when a rank 7 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer, a sixth PUSCH layer and a seventh PUSCH layer are transmitted by antenna ports from the second antenna group; and when a rank 8 PUSCH is scheduled for UE with Ng=2, a first PUSCH layer, a second PUSCH layer, a third PUSCH layer and a fourth PUSCH layer are transmitted by antenna ports from the first antenna group, and a fifth PUSCH layer, a sixth PUSCH layer, a seventh PUSCH layer and an eighth PUSCH layer are transmitted by antenna ports from the second antenna group.

In another embodiment, a method performed at a UE comprises receiving a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determining the precoding matrix for the scheduled PUSCH according to the rank and the one or two precoding matrices.

In still another embodiment, a base unit comprises a transceiver; and a processor coupled to the transceiver, wherein the processor is configured to transmit, via the transceiver, a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determine the precoding matrix for the scheduled PUSCH according to the rank and the one or two precoding matrices.

In yet another embodiment, a method performed at a base unit comprises transmitting a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determining the precoding matrix for the scheduled PUSCH according to the rank and the one or two precoding matrices.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates several antenna layouts with different number of antenna groups;

FIG. 2 illustrates an example of antenna layout 1-a and antenna layout 1-b;

FIG. 3 illustrates an example of antenna layout 2-a and antenna layout 2-b;

FIG. 4 illustrates an example of antenna layout 3-a and antenna layout 3-b;

FIG. 5 is a schematic flow chart diagram illustrating an embodiment of a method;

FIG. 6 is a schematic flow chart diagram illustrating an embodiment of another method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable rank and the precoding matrix from a pre-defined codebook, which includes a set of precoding matrices with different ranks, and sends the information to the UE when scheduling a PUSCH transmission.

For non-codebook based PUSCH transmission, the UE is required to measure a CSI-RS to obtain the uplink channel information based on channel reciprocity. In this case, a CSI-RS resource, which is a DL reference signaling transmitted by the gNB for DL channel measurement, is associated with the SRS resource set used for non-codebook. The UE selects what it believes is a suitable uplink precoder and applies the selected precoder to a set of configured SRS resources with one SRS resource transmitted on each layer defined by the precoder. Based on the received SRS resources, the gNB decides to modify the UE-selected precoder for the scheduled PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling a PUSCH transmission with up to 8 layers (i.e., PUSCH layers). The 8 antenna ports (e.g., PUSCH or SRS antenna ports) may be numbered as PUSCH or SRS antenna ports 1000, 1001, 1002, 1003, 1004, 1005, 1006, and 1007.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0} - 1 )} ( i )\end{matrix} ] \qquad Equation 1$$

where, the block of vector

$${[ {y}_{0}^{( 0 )} ( i ) … {y}_{0}^{( {v}_{0} - 1 )} ( i ) ]}^{T}$$

is the modulated data that will be transmitted; W₀ is the precoding matrix applied to the block of vector; and the block of vector

$${[ {z}_{0}^{( {P}_{0} )} ( i ) … {z}_{0}^{( {P}_{ρ - 1} )} ( i ) ]}^{T}$$

is the pre-coded data to be transmitted by the UE. v₀ indicates the number of PUSCH layers or the rank of the PUSCH. P₀ corresponds to PUSCH antenna port 1000 and P_{ρ-1} corresponds to PUSCH antenna port 1000+ρ−1. In this invention, ρ=8.

Coherent transmission is described as follows:

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

is a valid precoding vector for a rank 1 PUSCH transmission with 8 full coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

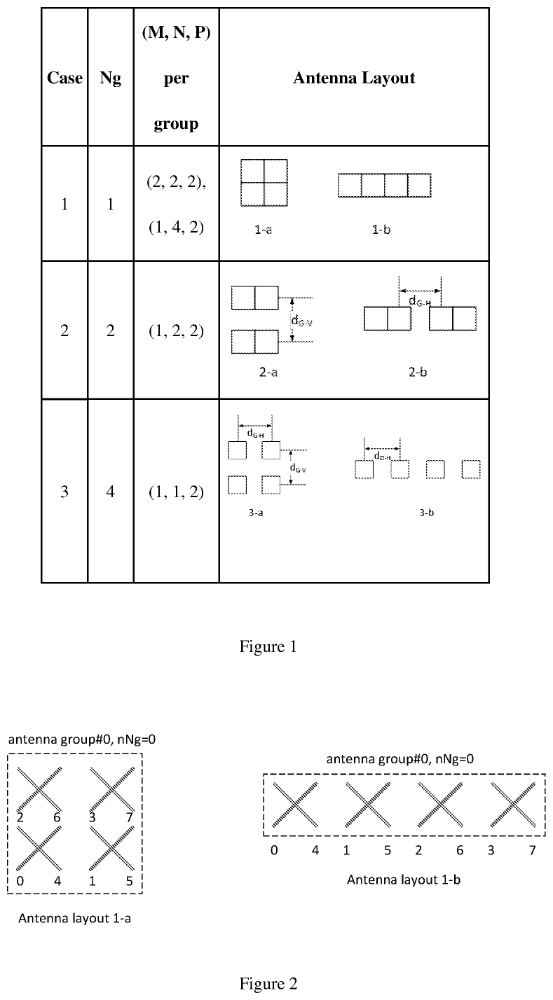

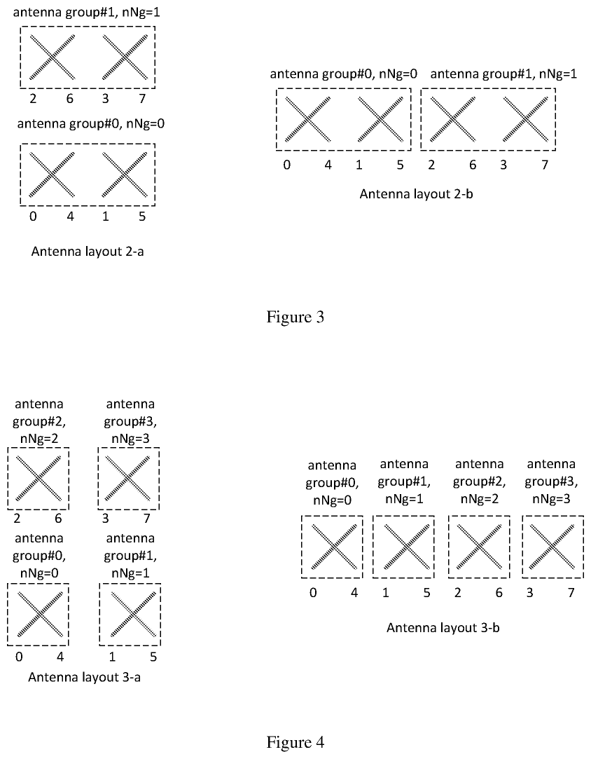

If a UE reports capability of partial-coherent or non-coherent with 8 antenna ports (i.e., PUSCH antenna port 1000, 1001, 1002, 1003, 1004, 1005, 1006 and 1007), only coherent antenna ports (where the coherent antenna ports are a part of the 8 antenna ports) can be used for transmission of one PUSCH layer. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 1.

In FIG. 1, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna port.

Antenna layout 1-a and antenna layout 1-b correspond to full coherent antenna array, i.e., all 8 antenna ports within each of antenna layout 1-a and antenna layout 1-b belong to one antenna group (e.g., antenna group #0, denoted as nNg=0) and are coherent antenna ports.

Antenna layout 2-a and antenna layout 2-b correspond to partial coherent antenna array with two antenna groups (Ng=2). For example, in each of antenna layout 2-a and antenna layout 2-b, each of antenna group #0 (a first antenna group, denoted as nNg=0) and antenna group #1 (a second antenna group, denoted as nNg=1) includes four coherent antenna ports.

Antenna layout 3-a and antenna layout 3-b correspond to partial coherent antenna array with four antenna groups (Ng=4). For example, in each of antenna layout 3-a and antenna layout 3-b, each of antenna group #0 (a first antenna group, denoted as nNg=0), antenna group #1 (a second antenna group, denoted as nNg=1), antenna group #2 (a third antenna group, denoted as nNg=2), and antenna group #3 (a fourth antenna group, denoted as nNg=3) includes two coherent antenna ports.

Before discussing the codebook design, the UE needs to report its antenna layout including the number of antenna groups 1≤Ng≤4, and optionally the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

For partial coherent UE, i.e., Ng=2 or Ng=4, a same precoding scheme shall be applied to both antenna layouts 2-a and 2-b, and antenna layouts 3-a and 3-b.

The UE can report the supported maxRank ∈ {1, 2, 3, 4, 5, 6, 7, 8}, i.e., the maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than maxRank. A precoding matrix (which can also be referred to as precoder) shall be determined for the scheduled PUSCH transmission.

Incidentally, the number of columns of the precoding matrix indicates the number of layers of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder. The number of rows of the precoding matrix (precoder) indicates the number of antenna ports for which the precoding matrix can be applied. For example, the precoding matrix (precoder) may have 2 or 4 or 8 rows (denoted as 2Tx, 4Tx, 8Tx) for a UE with 2 antenna ports or 4 antenna ports or 8 antenna ports.

A first embodiment relates to precoder for rank=1 (rank 1 precoder).

For rank=1, one PUSCH layer (i.e., a single layer) is scheduled for transmission. The single layer is transmitted by antenna port(s) from one antenna group (for both Ng=2 and Ng=4).

A first sub-embodiment of the first embodiment relates to Ng=2.

The rank 1 precoder for UE with Ng=2 according to the first sub-embodiment of the first embodiment is constructed by the following steps:

Step 111: Select an antenna group (i.e., one of the first antenna group (nNg=0) and the second antenna group (nNg=1) for the single layer transmission.

Step 112: Select a 4Tx single-layer precoder W_{4Tx,1} from Table 6.3.1.5-2 (for DFT-s-OFDM) or Table 6.3.1.5-3 (for CP-OFDM), which are specified in 3GPP Technical Specification TS38.211 V16.0.0, and apply the precoding vector element of the selected 4Tx single-layer precoder without normalization factor to the antenna ports corresponding to the selected antenna group (one of the first antenna group and the second antenna group). The other elements corresponding to the non-selected antenna group (the other of the first antenna group and the second antenna group) in the single layer are set to ‘0’.

Step 113: set the normalization factor of the final 8Tx precoder as

$$\frac{1}{2 \sqrt{2}} .$$

TABLE 6.3.1.5-2
Precoding matrix W for single-layer transmission using four antenna ports with
transform precoding enabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}\begin{matrix}1 \\ 0 \\ 0\end{matrix} \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 6.3.1.5-3

| Precoding matrix W for single-layer transmission using four antenna ports with | | | | | | | | |
|---|---|---|---|---|---|---|---|---|
| transform precoding disabled. | | | | | | | | |
| TPMI | W | | | | | | | |
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-7 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

A first example of the first sub-embodiment of the first embodiment is described as follows: In step 111, the first antenna group (nNg=0) is selected. In step 112, 4Tx single-layer precoder

$${W}_{4 Tx , 1} = {\frac{1}{2} [ 11 j j ]}^{T}$$

(i.e., TPMI index=13) is selected, and the precoding vector element (i.e., [1 1 j j]^{T}) of the selected 4Tx single-layer precoder without normalization factor is applied to the antenna ports 0, 1, 4, 5 corresponding to the selected first antenna group. The other elements corresponding to the non-selected second antenna group in the single layer are set to ‘0’. In step 113, the normalization factor is set as

$$\frac{1}{2 \sqrt{2}} .$$

So, the 8Tx rank 1 precoder is constructed as

$${W}_{8 Tx 1} = {\frac{1}{2 \sqrt{2}} [ 1100 j j 00 ]}^{T} .$$

A second example of the first sub-embodiment of the first embodiment is described as follows: In step 111, the second antenna group (nNg=1) is selected. In step 112, 4Tx single-layer precoder

$${W}_{4 Tx , 1} = {\frac{1}{2} [ 1 - j 1 - j ]}^{T}$$

(i.e., TPMI index=24) is selected, and the precoding vector element (i.e., [1-j 1-j]^{T}) of the selected 4Tx single-layer precoder without normalization factor is applied to the antenna ports 2, 3, 6, 7 corresponding to the selected second antenna group. The other elements corresponding to the non-selected first antenna group in the single layer are set to ‘0’. In step 113, the normalization factor is set as

$$\frac{1}{2 \sqrt{2}} .$$

So, the 8Tx rank 1 precoder is constructed as

$${W}_{8 Tx 1} = {\frac{1}{2 \sqrt{2}} [ 001 - j 001 - j ]}^{T} .$$

A second sub-embodiment of the first embodiment relates to Ng=4.

The rank 1 precoder for UE with Ng=4 according to the second sub-embodiment of the first embodiment is constructed by the following steps:
Step 121: Select an antenna group (i.e., one of the first antenna group (nNg=0), the second antenna group (nNg=1), the third antenna group (nNg=2), and the fourth antenna group (nNg=3)) for the single layer transmission.
Step 122: Select a 2Tx single-layer precoder from candidate 2Tx single-layer precoders including

$${W}_{2 Tx , 1} ∈ \{ \frac{1}{\sqrt{2}} [ \begin{matrix}1 \\ 0\end{matrix} ] , \frac{1}{\sqrt{2}} [ \begin{matrix}0 \\ 1\end{matrix} ] , \frac{1}{\sqrt{2}} [ \begin{matrix}1 \\ 1\end{matrix} ] , \frac{1}{\sqrt{2}} [ \begin{matrix}1 \\ - 1\end{matrix} ] , \frac{1}{\sqrt{2}} [ \begin{matrix}1 \\ j\end{matrix} ] , \frac{1}{\sqrt{2}} [ \begin{matrix}1 \\ - j\end{matrix} ] \} ,$$

and apply the precoding vector element of the selected 2Tx single-layer precoder without normalization factor to the antenna ports corresponding to the selected antenna group. The other elements corresponding to the non-selected antenna groups in the single layer are set to ‘0’.
Step 123: set the normalization factor as

$$\frac{1}{2 \sqrt{2}} .$$

A first example of the second sub-embodiment of the first embodiment is described as follows: In step 121, the first antenna group (nNg=0) is selected. In step 122, 2Tx single-layer precoder

$$\frac{1}{\sqrt{2}} [ \begin{matrix}1 \\ 0\end{matrix} ]$$

is selected, and the precoding vector element (i.e., [1 0]^{T}) of the selected 2Tx single-layer precoder without normalization factor is applied to the antenna ports 0, 4 corresponding to the selected first antenna group. The other elements corresponding to the non-selected antenna groups (i.e., the second antenna group, the third antenna group and the fourth antenna group) in the single layer are set to ‘0’. In step 123, the normalization factor is set as

$$\frac{1}{2 \sqrt{2}} .$$

So, the 8Tx rank 1 precoder is constructed as

$$\frac{1}{2 \sqrt{2}} [ \begin{matrix}1 \\ 0 \\ 0 \\ 0 \\ 0 \\ 0 \\ 0 \\ 0\end{matrix} ] .$$

Similarly, if in step 122, one of 2Tx rank 1 precoders

$$\frac{1}{\sqrt{2}} [ \begin{matrix}0 \\ 1\end{matrix} ] , \frac{1}{\sqrt{2}} [ \begin{matrix}1 \\ 1\end{matrix} ] , \frac{1}{\sqrt{2}} [ \begin{matrix}1 \\ - 1\end{matrix} ] , \frac{1}{\sqrt{2}} [ \begin{matrix}1 \\ j\end{matrix} ] , \frac{1}{\sqrt{2}} [ \begin{matrix}1 \\ - j\end{matrix} ]$$

is selected, the 8Tx rank 1 precoder is constructed as one of

$$\frac{1}{2 \sqrt{2}} [ \begin{matrix}0 \\ 0 \\ 0 \\ 0 \\ 1 \\ 0 \\ 0 \\ 0\end{matrix} ] , \frac{1}{2 \sqrt{2}} [ \begin{matrix}1 \\ 0 \\ 0 \\ 0 \\ 1 \\ 0 \\ 0 \\ 0\end{matrix} ] , \frac{1}{2 \sqrt{2}} [ \begin{matrix}1 \\ 0 \\ 0 \\ 0 \\ - 1 \\ 0 \\ 0 \\ 0\end{matrix} ] , \frac{1}{2 \sqrt{2}} [ \begin{matrix}1 \\ 0 \\ 0 \\ 0 \\ j \\ 0 \\ 0 \\ 0\end{matrix} ] , \frac{1}{2 \sqrt{2}} [ \begin{matrix}1 \\ 0 \\ 0 \\ 0 \\ - j \\ 0 \\ 0 \\ 0\end{matrix} ] ,$$

respectively.

In a second example of the second sub-embodiment of the first embodiment, one of the second antenna group, the third antenna group and the fourth antenna group is selected. So, the available 8Tx rank 1 precoders for the second antenna group include

$$\frac{1}{2 \sqrt{2}} [ \begin{matrix}0 \\ 1 \\ 0 \\ 0 \\ 0 \\ 0 \\ 0 \\ 0\end{matrix} ] , \frac{1}{2 \sqrt{2}} [ \begin{matrix}0 \\ 0 \\ 0 \\ 0 \\ 0 \\ 1 \\ 0 \\ 0\end{matrix} ] , \frac{1}{2 \sqrt{2}} [ \begin{matrix}0 \\ 1 \\ 0 \\ 0 \\ 0 \\ 1 \\ 0 \\ 0\end{matrix} ] , \frac{1}{2 \sqrt{2}} [ \begin{matrix}0 \\ 1 \\ 0 \\ 0 \\ 0 \\ - 1 \\ 0 \\ 0\end{matrix} ] , \frac{1}{2 \sqrt{2}} [ \begin{matrix}0 \\ 1 \\ 0 \\ 0 \\ - j \\ j \\ 0 \\ 0\end{matrix} ] , \frac{1}{2 \sqrt{2}} [ \begin{matrix}0 \\ 1 \\ 0 \\ 0 \\ 0 \\ - j \\ 0 \\ 0\end{matrix} ] ;$$

the available 8Tx rank 1 precoders for the third antenna group include

$$\begin{matrix}\frac{1}{2 \sqrt{2}} [ \begin{matrix}0 \\ 0 \\ 1 \\ 0 \\ 0 \\ 0 \\ 0 \\ 0\end{matrix} ] , \frac{1}{2 \sqrt{2}} [ \begin{matrix}0 \\ 0 \\ 0 \\ 0 \\ 0 \\ 0 \\ 1 \\ 0\end{matrix} ] , \frac{1}{2 \sqrt{2}} [ \begin{matrix}0 \\ 0 \\ 1 \\ 0 \\ 0 \\ 0 \\ 1 \\ 0\end{matrix} ] , \frac{1}{2 \sqrt{2}} [ \begin{matrix}0 \\ 0 \\ 1 \\ 0 \\ 0 \\ 0 \\ - 1 \\ 0\end{matrix} ] , \frac{1}{2 \sqrt{2}} [ \begin{matrix}0 \\ 0 \\ 1 \\ 0 \\ 0 \\ 0 \\ j \\ 0\end{matrix} ] , \frac{1}{2 \sqrt{2}} [ \begin{matrix}0 \\ 0 \\ 1 \\ 0 \\ 0 \\ 0 \\ - j \\ 0\end{matrix} ] \\ \frac{1}{2 \sqrt{2}} [ \begin{matrix}0 \\ 0 \\ 1 \\ 0 \\ 0 \\ 0 \\ 0 \\ 0\end{matrix} ] , \frac{1}{2 \sqrt{2}} [ \begin{matrix}0 \\ 0 \\ 0 \\ 0 \\ 0 \\ 0 \\ 1 \\ 0\end{matrix} ] , \frac{1}{2 \sqrt{2}} [ \begin{matrix}0 \\ 0 \\ 1 \\ 0 \\ 0 \\ 0 \\ 1 \\ 0\end{matrix} ] , \frac{1}{2 \sqrt{2}} [ \begin{matrix}0 \\ 0 \\ 1 \\ 0 \\ 0 \\ 0 \\ - 1 \\ 0\end{matrix} ] , \frac{1}{2 \sqrt{2}} [ \begin{matrix}0 \\ 0 \\ 1 \\ 0 \\ 0 \\ 0 \\ j \\ 0\end{matrix} ] , \frac{1}{2 \sqrt{2}} [ \begin{matrix}0 \\ 0 \\ 1 \\ 0 \\ 0 \\ 0 \\ - j \\ 0\end{matrix} ] ;\end{matrix}$$

and the available 8Tx rank 1 precoders for the fourth antenna group include

$$\frac{1}{2 \sqrt{2}} [ \begin{matrix}0 \\ 0 \\ 0 \\ 1 \\ 0 \\ 0 \\ 0 \\ 0\end{matrix} ] , \frac{1}{2 \sqrt{2}} [ \begin{matrix}0 \\ 0 \\ 0 \\ 0 \\ 0 \\ 0 \\ 0 \\ 1\end{matrix} ] , \frac{1}{2 \sqrt{2}} [ \begin{matrix}0 \\ 0 \\ 0 \\ 1 \\ 0 \\ 0 \\ 0 \\ 1\end{matrix} ] . \frac{1}{2 \sqrt{2}} [ \begin{matrix}0 \\ 0 \\ 0 \\ 1 \\ 0 \\ 0 \\ 0 \\ - 1\end{matrix} ] , \frac{1}{2 \sqrt{2}} [ \begin{matrix}0 \\ 0 \\ 0 \\ 1 \\ 0 \\ 0 \\ 0 \\ j\end{matrix} ] , \frac{1}{2 \sqrt{2}} [ \begin{matrix}0 \\ 0 \\ 0 \\ 1 \\ 0 \\ 0 \\ 0 \\ - j\end{matrix} ] .$$

A second embodiment relates to precoder for rank=2 (rank 2 precoder).

For rank=2, two PUSCH layers (i.e., a first layer and a second layer) are scheduled for transmission. The first layer and the second layer are transmitted by antenna port(s) from two antenna groups (for both Ng=2 and Ng=4).

A first sub-embodiment of the second embodiment relates to Ng=2.

The first layer and the second layer shall be transmitted by the first antenna group (nNg=0) and the second antenna group (nNg=1), respectively.

The rank 2 precoder according to the first sub-embodiment of the second embodiment is constructed by the following steps:
Step 211: Select a 4Tx two-layer precoder from Table 6.3.1.5-5 specified in 3GPP TS38.211 V16.0.0, apply the first precoding vector (i.e., first column) of the selected 4Tx rank 2 precoder without normalization factor to the antenna ports corresponding to the first antenna group, and apply the second precoding vector (i.e., second column) of the selected 4Tx rank 2 precoder without normalization factor to the antenna ports corresponding to the second antenna group. The other elements corresponding to the non-selected antenna group in each layer (each of the first layer and the second layer) are set to ‘0’.
Step 212: set the normalization factor as

$$\frac{1}{2 \sqrt{2}} .$$

TABLE 6.3.1.5-5
Precoding matrix W for two-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ 1 & 1 \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

An example of the first sub-embodiment of the second embodiment is described as follows: In step 211, 4Tx two layer precoder

$${W}_{4 Tx , 2} = {\frac{1}{2 \sqrt{2}} [ \begin{matrix}1 & j & 1 & j \\ 1 & j & - 1 & - j\end{matrix} ]}^{T}$$

(i.e., TPMI index=16) is selected, the first precoding vector (i.e., [1 j 1 j]^{T}) of the selected 4Tx two-layer precoder without normalization factor is applied to the antenna ports 0, 1, 4, 5 corresponding to the first antenna group, and the second precoding vector (i.e., [1 j −1 j]^{T}) of the selected 4Tx two-layer precoder without normalization factor is applied to the antenna ports 2, 3, 6, 7 corresponding to the second antenna group. The other elements corresponding to the non-selected antenna group in each of the first layer and the second layer are set to ‘0’. In step 212, the normalization factor is set as

$$\frac{1}{2 \sqrt{2}} .$$

So, the 8Tx rank 2 precoder is constructed as

$${W}_{8 Tx , 2} = \frac{1}{2 \sqrt{2}} [ \begin{matrix}1 & j & 1 & j \\ 1 & j & - 1 & - j\end{matrix} ]$$

A second sub-embodiment of the second embodiment relates to Ng=4.

The 8Tx rank 2 precoder for UE with Ng=4 according to the second sub-embodiment of the second embodiment is constructed by the following steps:
Step 221: Select 2 antenna groups out of the 4 antenna groups (i.e., the first antenna group (nNg=0), the second antenna group (nNg=1), the third antenna group (nNg=2) and the fourth antenna group (nNg=3)) for the two layers transmission from candidate 2 antenna groups including {nNg=0, nNg=1}, {nNg=0, nNg=21, {nNg=0, nNg=3}, {nNg=1, nNg=2}, {nNg=1, nNg=3}, and {nNg=2, nNg=3}. For example, if {nNg=0, nNg=1} is selected, nNg=0 is the first selected antenna group, and nNg=1 is the second selected antenna group.
Step 222: Select a 2Tx two-layer precoder W_{Tx2} from candidate 2Tx two-layer precoders including

$$\begin{matrix}{W}_{2 Tx 2} = \frac{1}{\sqrt{2}} [ \begin{matrix}1 & 0 \\ 0 & 1\end{matrix} ] , {W}_{2 Tx 2} = \frac{1}{2} [ \begin{matrix}1 & 1 \\ 1 & - 1\end{matrix} ] , {W}_{2 Tx , 2} [ \begin{matrix}1 & 1 \\ j & - j\end{matrix} ] , {W}_{2 T x 2} = \frac{1}{\sqrt{2}} [ \begin{matrix}1 & 0 \\ 0 & 1\end{matrix} ] , {W}_{2 T x 2} = \frac{1}{2} [ \begin{matrix}1 & 1 \\ 1 & j\end{matrix} ] , \\ {W}_{2 Tx 2} = \frac{1}{\sqrt{2}} [ \begin{matrix}1 & 1 \\ 1 & - j\end{matrix} ] ,\end{matrix}$$

and apply the first precoding vector element (i.e., first column) of the selected 2Tx two-layer precoder without normalization factor to the antenna ports corresponding to the first selected antenna group, and apply the second precoding vector element (i.e., second column) of the selected 2Tx two-layer precoder without normalization factor to the antenna ports corresponding to the second selected antenna group. The other elements corresponding to the non-selected antenna groups in each layer (each of the first layer and the second layer) are set to ‘0’.
Step 223: set the normalization factor as

$$\frac{1}{2 \sqrt{2}} .$$

An example of the second sub-embodiment of the second embodiment is described as follows: in step 221, two antenna groups {nNg=0, nNg=1} or {nNg=0, nNg=2}or {nNg=0, nNg=3}or {nNg=1, nNg=2}or {nNg=1, nNg=3}, or {nNg=2, nNg=3} is selected. In Step 222,

$${W}_{2 Tx 2} = \frac{1}{\sqrt{2}} [ \begin{matrix}1 & 1 \\ j & - j\end{matrix} ]$$

is selected, and the first precoding vector element of the selected 2Tx two-layer precoder (i.e., [1 j]^{T}) without normalization factor is applied to the antenna ports corresponding to the first selected antenna group, and the second precoding vector element (i.e., [1−j]^{T}) of the selected 2Tx two-layer precoder without normalization factor is applied to the antenna ports corresponding to the second selected antenna group. The other elements corresponding to the non-selected antenna groups in each of the first layer and the second layer are set to ‘0’. So, the 8Tx rank 2 precoder is constructed as one of

$$\begin{matrix}\begin{matrix}{W}_{8 Tx 2} = {\frac{1}{\sqrt{2}} [ \begin{matrix}1 & 0 & 0 & 0 & j & 0 & 0 & 0 \\ 0 & 1 & 0 & 0 & 0 & - j & 0 & 0\end{matrix} ]}^{T} , {W}_{8 Tx 2} = {\frac{1}{\sqrt{2}} [ \begin{matrix}1 & 0 & 0 & 0 & 0 & j & 0 & 0 \\ 0 & 0 & 1 & 0 & 0 & 0 & - j & 0\end{matrix} ]}^{T} , \\ {W}_{8 Tx 2} = {\frac{1}{\sqrt{2}} [ \begin{matrix}1 & 0 & 0 & 0 & j & 0 & 0 & 0 \\ 0 & 0 & 0 & 1 & 0 & 0 & 0 & - j\end{matrix} ]}^{T} , {W}_{8 Tx 2} = {\frac{1}{\sqrt{2}} [ \begin{matrix}0 & 1 & 0 & 0 & 0 & j & 0 & 0 \\ 0 & 0 & 1 & 0 & 0 & 0 & - j & 0\end{matrix} ]}^{T} ,\end{matrix} \\ {W}_{8 Tx , 2} = {\frac{1}{2 \sqrt{2}} [ \begin{matrix}0 & 1 & 0 & 0 & 0 & j & 0 & 0 \\ 0 & 0 & 0 & 1 & 0 & 0 & 0 & - j\end{matrix} ]}^{T} and {W}_{8 Tx , 2} = {\frac{1}{2 \sqrt{2}} [ \begin{matrix}0 & 0 & 1 & 0 & 0 & 0 & j & 0 \\ 0 & 0 & 0 & 1 & 0 & 0 & 0 & - j\end{matrix} ]}^{T}\end{matrix}$$

for each of two antenna groups including {nNg=0, nNg=1}, {nNg=0, nNg=2}, {nNg=0, nNg=3}, {nNg=1, nNg=2}, {nNg=1, nNg=3}, and {nNg=2, nNg=3}.

A third embodiment relates to precoder for rank=3 (rank 3 precoder).

For rank=3, three PUSCH layers (i.e., a first layer, a second layer and a third layer) are scheduled for transmission. The first layer and the second layer are transmitted by antenna port(s) from two antenna groups (for Ng=2) or from three antenna groups (for Ng=4).

A first sub-embodiment of the third embodiment relates to Ng=2.

The first layer shall be transmitted by the first antenna group (nNg=0), and the second layer and the third layer shall be transmitted by the second antenna group (nNg=1).

The rank 3 precoder for UE with Ng=2 according to the first sub-embodiment of the third embodiment is constructed by the following steps:
Step 311: Select a 4Tx three-layer precoder from Table 6.3.1.5-6 specified in 3GPP TS38.211 V16.0.0, and apply the first precoding vector (i.e., first column) of the selected 4Tx three-layer precoder without normalization factor to the antenna ports corresponding to the first antenna group for the first layer, and apply the last two (i.e., the second and the third) precoding vectors (i.e., the second column and the third column) of the selected 4Tx three-layer precoder without normalization factor to the antenna ports corresponding to the second antenna group for the second layer and the third layer. The other elements corresponding to the non-selected antenna group in each layer (each of the first layer, the second layer and the third layer) are set to ‘0’.
Step 312: Set the normalization factor as¼.

TABLE 6.3.1.5-6
Precoding matrix W for three-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

An example of the first sub-embodiment of the third embodiment is described as follows: in Step 311, 4Tx rank 3 precoder

$${W}_{4 Tx , 3} = {\frac{1}{2 \sqrt{3}} [ \begin{matrix}1 & 1 & 1 & 1 \\ 1 & - 1 & 1 & - 1 \\ 1 & 1 & - 1 & - 1\end{matrix} ]}^{T}$$

(i.e., TPMI index=3) is selected, and the first precoding vector (i.e., first column) of the selected 4Tx rank 3 precoder without normalization factor (i.e., [1 1 1 1]^{T}) is applied to the antenna ports 0, 1, 4, 5 corresponding to the first antenna group for the first layer, and apply the second and the third precoding vectors (i.e., second column and third column) of the selected 4Tx three-layer precoder without normalization factor (i.e., [1-1 1-1]^{T} and [1 1-1 −1]^{T}) to the antenna ports 2, 3, 6, 7 corresponding to the second antenna group for the second layer and the third layer. The other elements corresponding to the non-selected antenna group in each of the first layer, the second layer and the third layer are set to ‘0’. In step 312, the normalization factor is set as ¼. So, the 8Tx rank 3 precoder is constructed as

$${W}_{8 Tx , 3} = {\frac{1}{4} [ \begin{matrix}1 & 1 & 0 & 0 & 1 & 1 & 0 & 0 \\ 0 & 0 & 1 & - 1 & 0 & 0 & 1 & - 1 \\ 0 & 0 & 1 & 1 & 0 & 0 & - 1 & - 1\end{matrix} ]}^{T} .$$

A second sub-embodiment of the third embodiment relates to Ng=4.

The 8Tx rank 3 precoder for UE with Ng=4 according to the second sub-embodiment of the third embodiment is constructed by the following steps:
Step 321: Select 3 antenna groups out of the 4 antenna groups (i.e., the first antenna group (nNg=0), the second antenna group (nNg=1), the third antenna group (nNg=2) and the fourth antenna group (nNg=3)) for the three layers transmission from candidate three antenna groups including {nNg=0, nNg=1, nNg=2}, {nNg=0, nNg=1, nNg=3}, {nNg=0, nNg=2, nNg=3} and {nNg=1, nNg=2, nNg=3}. For example, if {nNg=0, nNg=1, nNg=3} is selected, nNg=0 is the first selected antenna group, nNg=1 is the second selected antenna group, nNg=3 is the third selected antenna group.
Step 322: Select a 2Tx three-layer precoder matrix W_{2Tx,3} from candidate 2Tx three-layer precoders including

$$\begin{matrix}{W}_{2 Tx , 3} = [ \begin{matrix}1 & 0 & 1 \\ 0 & 1 & 0\end{matrix} ] , {W}_{2 Tx , 3} = [ \begin{matrix}1 & 0 & 0 \\ 0 & 1 & 1\end{matrix} ] {W}_{2 Tx , 3} = [ \begin{matrix}1 & 1 & 0 \\ 0 & 0 & 1\end{matrix} ] \\ {W}_{2 Tx , 3} = [ \begin{matrix}1 & 1 & 1 \\ 1 & - 1 & j\end{matrix} ] , {W}_{2 Tx , 3} = [ \begin{matrix}1 & 1 & 1 \\ 1 & - 1 & - j\end{matrix} ] {W}_{2 Tx , 3} = [ \begin{matrix}1 & 1 & 1 \\ 1 & j & - j\end{matrix} ] , and {W}_{2 Tx , 3} = [ \begin{matrix}1 & 1 & 1 \\ - 1 & j & - j\end{matrix} ] ,\end{matrix}$$

and apply the first precoding vector element (i.e., first column) of the selected 2Tx three-layer precoder without normalization factor to the antenna ports corresponding to the first selected antenna group, and apply the second precoding vector element (i.e., second column) of the selected 2Tx three-layer precoder without normalization factor to the antenna ports corresponding to the second selected antenna group, and apply the third precoding vector element (i.e., third column) of the selected 2Tx three-layer precoder without normalization factor to the antenna ports corresponding to the third selected antenna group. The other elements corresponding to the non-selected antenna groups in each layer (each of the first layer, the second layer and the third layer) are set to ‘0’.

$$\frac{1}{2 \sqrt{2}} .$$

Step 323: set the normalization factor as.

A first example of the second sub-embodiment of the third embodiment is described as follows: in step 321, 3 antenna groups {nNg=0, nNg=1, nNg=3}are selected. In step 322, 2Tx three-layer precoder matrix

$${W}_{2 Tx , 3} = [ \begin{matrix}1 & 0 & 1 \\ 0 & 1 & 0\end{matrix} ]$$

is selected, and the first precoding vector element (i.e., first column) of the selected 2Tx three-layer precoder without normalization factor (i.e., [10]^{T}) is applied to the antenna ports 0, 4 corresponding to the first selected antenna group nNg=0, and the second precoding vector element (i.e., second column) of the selected 2Tx three-layer precoder without normalization factor (i.e., [0 1]^{T}) is applied to the antenna ports 1, 5 corresponding to the second selected antenna group nNg=1, and the third precoding vector element (i.e., third column) of the selected 2Tx three-layer precoder without normalization factor (i.e., [1 0]^{T}) is applied to the antenna ports 3, 7 corresponding to the third selected antenna group nNg=3. The other elements corresponding to the non-selected antenna groups in each of the first layer, the second layer and the third layer are set to ‘0’. In step 323, the normalization factor is set as

$$\frac{1}{2 \sqrt{2}} .$$

So, the 8Tx rank 3 precoder is constructed as

$${W}_{8 Tx , 3} = {\frac{1}{2 \sqrt{2}} [ \begin{matrix}1 & 0 & 0 & 0 & 0 & 0 & 0 & 0 \\ 0 & 0 & 0 & 0 & 0 & 1 & 0 & 0 \\ 0 & 0 & 0 & 1 & 0 & 0 & 0 & 0\end{matrix} ]}^{T} .$$

A second example of the second sub-embodiment of the third embodiment is described as follows: in step 321, three antenna groups {nNg=1, nNg=2, nNg=3}are selected. In step 322, 2Tx three-layer precoder matrix

$${W}_{2 Tx , 3} = [ \begin{matrix}1 & 1 & 1 \\ 1 & - 1 & - j\end{matrix} ]$$

is selected, and the first precoding vector element (i.e., first column) of the selected 2Tx three-layer precoder without normalization factor (i.e., [1 1]^{T}) is applied to the antenna ports 1, 5 corresponding to the first selected antenna group nNg=1, and the second precoding vector element (i.e., second column) of the selected 2Tx three-layer precoder without normalization factor (i.e., [1-1]^{T}) is applied to the antenna ports 2, 6 corresponding to the second selected antenna group nNg=2, and the third precoding vector element (i.e., third column) of the selected 2Tx three-layer precoder without normalization factor (i.e., [1 −j]^{T}) is applied to the antenna ports 3, 7 corresponding to the third selected antenna group nNg=3. The other elements corresponding to the non-selected antenna groups in each of the first layer, the second layer and the third layer are set to ‘0’. In step 323, the normalization factor is set as

$$\frac{1}{2 \sqrt{2}} .$$

So, the 8Tx rank 3 precoder is constructed as

$${W}_{8 Tx , 3} = {\frac{1}{2 \sqrt{2}} [ \begin{matrix}0 & 1 & 0 & 0 & 0 & 1 & 0 & 0 \\ 0 & 0 & 1 & 0 & 0 & 0 & - 1 & 0 \\ 0 & 0 & 0 & 1 & 0 & 0 & 0 & - j\end{matrix} ]}^{T} .$$

A fourth embodiment relates to precoder for rank=4 (rank 4 precoder).

For rank=4, four PUSCH layers (i.e., a first layer, a second layer, a third layer and a fourth layer) are scheduled for transmission. The 4 PUSCH layers shall be transmitted by antenna port(s) from 2 antenna groups (for Ng=2) or from 4 antenna groups (for Ng=4).

A first sub-embodiment of the fourth embodiment relates to Ng=2.

The first layer and the second layer shall be transmitted by the first antenna group (nNg=0) and the third layer and the fourth layer shall be transmitted by the second antenna group (nNg=1).

The rank 4 precoder for UE with Ng=2 according to the first sub-embodiment of the fourth embodiment is constructed by the following steps:
Step 411: Select a 4Tx four-layer precoder from Table 6.3.1.5-7 specified in 3GPP TS38.211 V16.0.0, and apply the first two (i.e., the first and the second) precoding vectors (i.e., first column and second column) of the selected 4Tx four-layer precoder without normalization factor to the antenna ports 0, 1, 4, 5 corresponding to the first antenna group, and apply the last two (i.e., the third and the fourth) precoding vectors (i.e., third column and fourth column) of the selected 4Tx four-layer precoder without normalization factor to the antenna ports 2, 3, 6, 7 corresponding to the second antenna group. The other elements corresponding to the non-selected antenna group in each layer (i.e., each of the first layer, the second layer, the third layer and the fourth layer) are set to ‘0’.
Step 412: Set the normalization factor as ¼.

TABLE 6.3.1.5-7
Precoding matrix W for four-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

A first example of the first sub-embodiment of the fourth embodiment is described as follows: In step 411,

$${W}_{4 Tx , 4} = {\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]}^{T}$$

(i.e., TPMI index=0) is selected, the first two (i.e., the first and the second) precoding vectors (i.e., first column and second column) of the selected 4Tx four-layer precoder without normalization factor (i.e., [1 0 0 0] and [0 1 0 0]^{T}) are applied to the antenna ports 0, 1, 4, 5 corresponding to the first antenna group for the first layer and the second layer, and the last two (i.e., the third and the fourth) precoding vectors (i.e., first column and second column) of the selected 4Tx four-layer precoder without normalization factor (i.e., [0 0 1 0]^{T} and [0 0 0 1]^{T}) are applied to the antenna ports 2, 3, 6, 7 corresponding to the second antenna group for the third layer and the fourth layer. The other elements corresponding to the non-selected antenna group in each of the first layer, the second layer, the third layer and the fourth layer are set to ‘0’. In step 412, the normalization factor is set as ¼. So, the 8Tx rank 4 precoder is constructed as

$${W}_{8 Tx , 4} = {\frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 0 & 0 & 0 & 0 & 1 & 0 \\ 0 & 0 & 0 & 0 & 0 & 0 & 0 & 1\end{matrix} ]}^{T} .$$

A second example of the first sub-embodiment of the fourth embodiment is described as follows: In step 411,

$${W}_{4 Tx , 4} = \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$$

(i.e., TPMI index 2) is selected, the first two (i.e., the first and the second) precoding vectors (i.e., first column and second column) of the selected 4Tx four-layer precoder without normalization factor (i.e., [1 0 j0]T and [1 0 −j 0]^{T}) are applied to the antenna ports 0, 1, 4, 5 corresponding to the first antenna group for the first layer and the second layer, and the last two (i.e., the third and the fourth) precoding vectors (i.e., first column and second column) of the selected 4Tx four-layer precoder without normalization factor (i.e., [0 1 0 j]^{T} and [0 1 0 −j]^{T}) are applied to the antenna ports 2, 3, 6, 7 corresponding to the second antenna group for the third layer and the fourth layer. The other elements corresponding to the non-selected antenna group in each of the first layer, the second layer, the third layer and the fourth layer are set to ‘0’. In step 412, the normalization factor is set as ¼. So, the 8Tx rank 4 precoder is constructed as

$${W}_{8 Tx , 4} = {\frac{1}{4} [ \begin{matrix}1 & 0 & 0 & 0 & j & 0 & 0 & 0 \\ 1 & 0 & 0 & 0 & - j & 0 & 0 & 0 \\ 0 & 0 & 0 & 1 & 0 & 0 & 0 & j \\ 0 & 0 & 0 & 1 & 0 & 0 & 0 & - j\end{matrix} ]}^{T} .$$

A second sub-embodiment of the fourth embodiment relates to Ng=4.

The first layer shall be transmitted by the first antenna group (nNg=0), the second layer shall be transmitted by the second antenna group (nNg=1), the third layer shall be transmitted by the third antenna group (nNg=2), and the fourth layer shall be transmitted by the fourth antenna group (nNg=3).

The rank 4 precoder for UE with Ng=4 according to the second sub-embodiment of the fourth embodiment is constructed by the following steps:
Step 421: Select a 2Tx four-layer precoder matrix W_{2Tx,4} from candidate 2Tx four-layer precoders

$$\begin{matrix}{W}_{2 Tx , 4} = [ \begin{matrix}1 & 0 & 1 & 0 \\ 0 & 1 & 0 & 1\end{matrix} ] , {W}_{2 Tx , 4} = [ \begin{matrix}1 & 1 & 1 & 1 \\ 1 & - 1 & 1 & - 1\end{matrix} ] , {W}_{2 Tx , 4} = [ \begin{matrix}1 & 1 & 1 & 1 \\ 1 & - 1 & j & - j\end{matrix} ] , and \\ {W}_{2 Tx , 4} = [ \begin{matrix}1 & 1 & 1 & 1 \\ j & - j & j & - j\end{matrix} ] ,\end{matrix}$$

and apply the first precoding vector (i.e., first column) of the selected 2Tx four-layer precoder without normalization factor to the antenna ports 0, 4 corresponding to the first antenna group, apply the second precoding vector (i.e., second column) of the selected 2Tx four-layer precoder without normalization factor to the antenna ports 1, 5 corresponding to the second antenna group, apply the third precoding vector (i.e., third column) of the selected 2Tx four-layer precoder without normalization factor to the antenna ports 2, 6 corresponding to the third antenna group, and apply the fourth precoding vector (i.e., fourth column) of the selected 2Tx four-layer precoder without normalization factor to the antenna ports 3, 7 corresponding to the fourth antenna group. The other elements corresponding to the non-selected antenna groups in each layer (i.e., each of the first layer, the second layer, the third layer and the fourth layer) are set to ‘0’.
Step 422: set the normalization factor as

$$\frac{1}{2 \sqrt{2}} .$$

An example of the second sub-embodiment of the fourth embodiment is described as follows: In step 421, one of

$$\begin{matrix}{W}_{2 Tx , 4} = [ \begin{matrix}1 & 0 & 1 & 0 \\ 0 & 1 & 0 & 1\end{matrix} ] , {W}_{2 Tx , 4} = [ \begin{matrix}1 & 1 & 1 & 1 \\ 1 & - 1 & 1 & - 1\end{matrix} ] , {W}_{2 Tx , 4} = [ \begin{matrix}1 & 1 & 1 & 1 \\ 1 & - 1 & j & - j\end{matrix} ] , \\ {W}_{2 Tx , 4} = [ \begin{matrix}1 & 1 & 1 & 1 \\ j & - j & j & - j\end{matrix} ] ,\end{matrix}$$

is selected, the first precoding vector (i.e., first column) of the selected 2Tx four-layer precoder without normalization factor (e.g., [1 0]^{T} for

$${W}_{2 Tx , 4} = [ \begin{matrix}1 & 0 & 1 & 0 \\ 0 & 1 & 0 & 1\end{matrix} ] )$$

is applied to the antenna ports 0, 4 corresponding to the first antenna group for the first layer, the second precoding vector (i.e., second column) of the selected 2Tx four-layer precoder without normalization factor (e.g., [0 1]^{T} for

$${W}_{2 Tx , 4} = [ \begin{matrix}1 & 0 & 1 & 0 \\ 0 & 1 & 0 & 1\end{matrix} ] )$$

is applied to the antenna ports 1, 5 corresponding to the second antenna group for the second layer, the third precoding vector (i.e., third column) of the selected 2Tx four-layer precoder without normalization factor (e.g., [1 0]^{T} for

$${W}_{2 Tx , 4} = [ \begin{matrix}1 & 0 & 1 & 0 \\ 0 & 1 & 0 & 1\end{matrix} ] )$$

is applied to the antenna ports 2, 6 corresponding to the third antenna group for the third layer, and the fourth precoding vector (i.e., fourth column) of the selected 2Tx four-layer precoder without normalization factor (e.g., [0 1]^{T} for

$${W}_{2 Tx , 4} = [ \begin{matrix}1 & 0 & 1 & 0 \\ 0 & 1 & 0 & 1\end{matrix} ] )$$

is applied to the antenna ports 3, 7 corresponding to the fourth antenna group for the fourth layer. The other elements corresponding to the non-selected antenna groups in each of the first layer, the second layer, the third layer and the fourth layer are set to ‘0’. In step 422, the normalization factor is set as

$$\frac{1}{2 \sqrt{2}} .$$

So, the 8Tx rank 4 precoder is constructed as one of

$$\begin{matrix}{W}_{8 Tx , 4} = \frac{1}{2 \sqrt{2}} [ \begin{matrix}1 & 0 & 0 & 0 & 0 & 0 & 0 & 0 \\ 0 & 0 & 0 & 0 & 0 & 1 & 0 & 0 \\ 0 & 0 & 1 & 0 & 0 & 0 & 0 & 0 \\ 0 & 0 & 0 & 0 & 0 & 0 & 0 & 1\end{matrix} ] ) \\ ( for {W}_{2 Tx , 4} = [ \begin{matrix}1 & 0 & 1 & 0 \\ 0 & 1 & 0 & 1\end{matrix} ] ) , {W}_{8 Tx , 4} = {\frac{1}{2 \sqrt{2}} [ \begin{matrix}1 & 0 & 0 & 0 & 1 & 0 & 0 & 0 \\ 0 & 1 & 0 & 0 & 0 & - 1 & 0 & 0 \\ 0 & 0 & 1 & 0 & 0 & 0 & 1 & 0 \\ 0 & 0 & 0 & 1 & 0 & 0 & 0 & 1\end{matrix} ]}^{T} ( for {W}_{2 Tx , 4} = [ \begin{matrix}1 & 1 & 1 & 1 \\ 1 & - 1 & 1 & - 1\end{matrix} ] ) , \\ {W}_{8 Tx , 4} = {\frac{1}{2 \sqrt{2}} [ \begin{matrix}1 & 0 & 0 & 0 & 1 & 0 & 0 & 0 \\ 0 & 1 & 0 & 0 & 0 & - 1 & 0 & 0 \\ 0 & 0 & 1 & 0 & 0 & 0 & j & 0 \\ 0 & 0 & 0 & 1 & 0 & 0 & 0 & - j\end{matrix} ]}^{T} ( for {W}_{2 Tx , 4} = [ \begin{matrix}1 & 1 & 1 & 1 \\ 1 & - 1 & j & - j\end{matrix} ] ) , and \\ {W}_{8 Tx , 4} = {\frac{1}{2 \sqrt{2}} [ \begin{matrix}1 & 0 & 0 & 0 & j & 0 & 0 & 0 \\ 0 & 1 & 0 & 0 & 0 & - j & 0 & 0 \\ 0 & 0 & 1 & 0 & 0 & 0 & j & 0 \\ 0 & 0 & 0 & 1 & 0 & 0 & 0 & - j\end{matrix} ]}^{T} ( for {W}_{2 Tx , 4} = [ \begin{matrix}1 & 1 & 1 & 1 \\ j & - j & j & - j\end{matrix} ] ) .\end{matrix}$$

A fifth embodiment relates precoder for rank >4 (i.e., rank=5, 6, 7 or 8) (rank 5 precoder, rank 6 precoder, rank 7 precoder, rank 8 precoder).

For rank >4 layers PUSCH transmission, it is assumed that two codewords (CWs) (i.e., a first CW (CW0) and a second CW (CW1)) shall be scheduled with the following CW to layer mapping rule (which is the same as the CW to layer mapping scheme for DL with more than 4 layers):
Rank 5: CW0 mapped to the first 2 layers (i.e., the first layer and the second layer) and CW1 mapped to the last 3 layers (i.e., the third layer, the fourth layer and the fifth layer);
Rank 6: CW0 mapped to the first 3 layers (i.e., the first layer, the second layer and the third layer) and CW1 mapped to the last 3 layers (i.e., the fourth layer, the fifth layer and the sixth layer);
Rank 7: CW0 mapped to the first 3 layers (i.e., the first layer, the second layer and the third layer) and CW1 mapped to the last 4 layers (i.e., the fourth layer, the fifth layer, the sixth layer and the seventh layer); and
Rank 8: CW0 mapped to the first 4 layers (i.e., the first layer, the second layer, the third layer and the fourth layer) and CW1 mapped to the last 4 layers (i.e., the fifth layer, the sixth layer, the seventh layer and the eighth layer).

A first sub-embodiment of the fifth embodiment relates to Ng=2.

For each of rank 5, rank 6, rank 7 and rank 8, each CW (each of CW0 and CW1) is transmitted by one antenna group. In particular, the layers mapped to CW0 are transmitted by the first antenna group (nNg=0), and the layers mapped to CW1 are transmitted by the second antenna group (nNg=1).

To simplify the specification workload, antenna group specific TPMI indication mechanism is proposed to construct the precoder for rank that is more than 4 (i.e., more than 4 layers). The TPMI is consisted of two parts (i.e., a first part and a second part), where the first part indicates a 4Tx precoder for the first antenna group and the second part indicates a 4Tx precoder for the second antenna group.

For rank=5, a 4Tx two-layer precoder from Table 6.3.1.5-5 specified in 3GPP TS38.211 V16.0.0 and a 4Tx three-layer precoder from Table 6.3.1.5-6 specified in 3GPP TS38.211 V16.0.0 are selected. The 4Tx two-layer precoder is applied to the antenna ports 0, 1, 4, 5 corresponding to the first antenna group for the first layer and the second layer. The 4Tx three-layer precoder is applied to the antenna ports 2, 3, 6, 7 corresponding to the second antenna group for the third layer, the fourth layer and the fifth layer. The final rank 5 precoding matrix should be normalized so that the power of the precoder is no more than 1.

For rank=6, a first 4Tx three-layer precoder from Table 6.3.1.5-6 specified in 3GPP TS38.211 V16.0.0 and a second 4Tx three-layer precoder from Table 6.3.1.5-6 specified in 3GPP TS38.211 V16.0.0 are selected. The first 4Tx three-layer precoder is applied to the antenna ports 0, 1, 4, 5 corresponding to the first antenna group for the first layer, the second layer and the third layer. The second 4Tx three-layer precoder is applied to the antenna ports 2, 3, 6, 7 corresponding to the second antenna group for the fourth layer, the fifth layer and the sixth layer. The final rank 6 precoding matrix should be normalized so that the power of the precoder is no more than 1

For rank=7, a 4Tx three-layer precoder from Table 6.3.1.5-6 specified in 3GPP TS38.211 V16.0.0 and a 4Tx four-layer precoder from Table 6.3.1.5-7 specified in 3GPP TS38.211 V16.0.0 are selected. The 4Tx three-layer precoder is applied to the antenna ports 0, 1, 4, 5 corresponding to the first antenna group for the first layer, the second layer and the third layer. The 4Tx four-layer precoder is applied to the antenna ports 2, 3, 6, 7 corresponding to the second antenna group for the fourth layer, the fifth layer, the sixth layer and the seventh layer.

The final rank 7 precoding matrix should be normalized so that the power of the precoder is no more than 1

For rank=8, a first 4Tx four-layer precoder from Table 6.3.1.5-7 specified in 3GPP TS38.211 V16.0.0 and a second 4Tx four-layer precoder from Table 6.3.1.5-7 specified in 3GPP TS38.211 V16.0.0 are selected. The first 4Tx four-layer precoder is applied to the antenna ports 0, 1, 4, 5 corresponding to the first antenna group for the first layer, the second layer, the third layer and the fourth layer. The second 4Tx four-layer precoder is applied to the antenna ports 2, 3, 6, 7 corresponding to the second antenna group for the fifth layer, the sixth layer, the seventh layer and the eighth layer. The final rank 8 precoding matrix should be normalized so that the power of the precoder is no more than 1

An example of the first sub-embodiment of the fifth embodiment is described as follows: when rank=5 is indicated and

$${W}_{4 Tx 2} = \frac{1}{2} [ \begin{matrix}1 & 0 \\ 0 & 1 \\ - 1 & 0 \\ 0 & - j\end{matrix} ] and {W}_{4 Tx 2} = \frac{1}{2} [ \begin{matrix}1 & 1 & 1 \\ 1 & - 1 & 1 \\ 1 & 1 & - 1 \\ 1 & - 1 & - 1\end{matrix} ]$$

are selected, the 4Tx two-layer precoder

$${W}_{4 Tx 2} = \frac{1}{2} [ \begin{matrix}1 & 0 \\ 0 & 1 \\ - 1 & 0 \\ 0 & - j\end{matrix} ]$$

is applied to the antenna ports 0, 1, 4, 5 corresponding to the first antenna group for the first layer and the second layer. The 4Tx three-layer precoder

$${W}_{4 Tx 2} = \frac{1}{2} [ \begin{matrix}1 & 1 & 1 \\ 1 & - 1 & 1 \\ 1 & 1 & - 1 \\ 1 & - 1 & - 1\end{matrix} ]$$

is applied to the antenna ports 2, 3, 6, 7 corresponding to the second antenna group for the third layer, the fourth layer and the fifth layer. So, the 8Tx rank 5 precoder is constructed as

$${W}_{8 Tx2} = \frac{1}{2} [ \begin{matrix}1 & 0 & 0 & 0 & 0 \\ 0 & 1 & 0 & 0 & 0 \\ 0 & 0 & 1 & 1 & 1 \\ 0 & 0 & 1 & - 1 & 1 \\ - 1 & 0 & 0 & 0 & 0 \\ 0 & - j & 0 & 0 & 0 \\ 0 & 0 & 1 & 1 & - 1 \\ 0 & 0 & 1 & - 1 & - 1\end{matrix} ] .$$

A second sub-embodiment of the fifth embodiment relates to Ng=4.

For each of rank 5, rank 6, rank 7 and rank 8, each CW (each of CW0 and CW1) is transmitted by two antenna groups. For example, the PUSCH layers mapped to CW0 are transmitted by the first antenna group and the second antenna group; and the PUSCH layers mapped to CW1 are transmitted by the third antenna group and the fourth antenna group.

The layer combinations, i.e., the number of layers transmitted by each antenna group, for Ng=4 are proposed as follows:

Rank 5 with two CWs: 1+1+2+1. That is, the first layer is transmitted by the first antenna group, the second layer is transmitted by the second antenna group, the third layer and the fourth layer are transmitted by the third antenna group, and the fifth layer is transmitted by the fourth antenna group.

Rank 6 with two CWs: 2+1+2+1. That is, the first layer and the second layer are transmitted by the first antenna group, the third layer is transmitted by the second antenna group, the fourth layer and the fifth layer are transmitted by the third antenna group, and the sixth layer is transmitted by the fourth antenna group.

Rank 7 with two CWs: 2+1+2+2. That is, the first layer and the second layer are transmitted by the first antenna group, the third layer is transmitted by the second antenna group, the fourth layer and the fifth layer are transmitted by the third antenna group, and the sixth layer and the seventh layer are transmitted by the fourth antenna group.

Rank 8 with two CWs: 2+2+2+2. That is, the first layer and the second layer are transmitted by the first antenna group, the third layer and the fourth layer are transmitted by the second antenna group, the fifth layer and the sixth layer are transmitted by the third antenna group, and the seventh layer and the eighth layer are transmitted by the fourth antenna group.

To simplify the specification workload, antenna group specific TPMI indication mechanism is proposed to construct the precoder for the rank that is more than 4 (i.e., more than 4 layers). The TPMI is consisted of two parts (i.e., a first part and a second part), where the first part indicates a 2Tx precoder for the first antenna group and the second antenna group, and the second part indicates a 2Tx precoder for the third antenna group and the fourth antenna group.

For rank=5, a 2Tx two-layer precoder selected from the candidate 2Tx two-layer precoders described in the second sub-embodiment of the second embodiment and a 2Tx three-layer precoder selected from the candidate 2Tx three-layer precoders described in the second sub-embodiment of the third embodiment are selected. The first precoding vector (i.e., first column) of the selected 2Tx two-layer precoder is applied to the antenna ports 0, 4 corresponding to the first antenna group for the first layer, the second precoding vector (i.e., second column) of the selected 2Tx two-layer precoder is applied to the antenna ports 1, 5 corresponding to the second antenna group for the second layer, the first and the second precoding vectors (i.e., first column and second column) of the selected 2Tx three-layer precoder are applied to the antenna ports 2, 6 corresponding to the third antenna group for the third layer and the fourth layer, and the third precoding vector (i.e., third column) of the selected 2Tx three-layer precoder is applied to the antenna ports 3, 7 corresponding to the fourth antenna group for the fifth layer. The final rank 5 precoding matrix should be normalized so that the power of the precoder is no more than 1

For rank=6, a first 2Tx three-layer precoder selected from the candidate 2Tx three-layer precoders described in the second sub-embodiment of the third embodiment and a second 2Tx three-layer precoder selected from the candidate precoders described in the second sub-embodiment of the third embodiment are selected. The first and the second precoding vectors (i.e., first column and second column) of the first selected 2Tx three-layer precoder are applied to the antenna ports 0, 4 corresponding to the first antenna group for the first layer and the second layer, the third precoding vector (i.e., third column) of the first selected 2Tx three-layer precoder is applied to the antenna ports 1, 5 corresponding to the second antenna group for the third layer, the first and the second precoding vectors (i.e., first column and the second column) of the second selected 2Tx three-layer precoder are applied to the antenna ports 2, 6 corresponding to the third antenna group for the fourth layer and the fifth layer, and the third precoding vector (i.e., third column) of the second selected 2Tx three-layer precoder is applied to the antenna ports 3, 7 corresponding to the fourth antenna group for the sixth layer. The final rank 6 precoding matrix should be normalized so that the power of the precoder is no more than 1

For rank=7, a 2Tx three-layer precoder selected from the candidate 2Tx three-layer precoders described in the second sub-embodiment of the third embodiment and a 2Tx four-layer precoder selected from the candidate 2Tx four-layer precoders described in the second sub-embodiment of the fourth embodiment are selected. The first and the second precoding vectors (i.e., first column and second column) of the selected 2Tx three-layer precoder are applied to the antenna ports 0, 4 corresponding to the first antenna group for the first layer and the second layer, the third precoding vector (i.e., third column) of the selected 2Tx three-layer precoder is applied to the antenna ports 1, 5 corresponding to the second antenna group for the third layer, the first and the second precoding vectors (i.e., first column and second column) of the selected 2Tx four-layer precoder are applied to the antenna ports 2, 6 corresponding to the third antenna group for the fourth layer and the fifth layer, and the third and the fourth precoding vectors (i.e., third column and fourth column) of the selected 2Tx four-layer precoder are applied to the antenna ports 3, 7 corresponding to the fourth antenna group for the sixth layer and the seventh layer. The final rank 7 precoding matrix should be normalized so that the power of the precoder is no more than 1

For rank=8, a first 2Tx four-layer precoder selected from the candidate2Tx four-layer precoders described in the second sub-embodiment of the fourth embodiment and a second 2Tx four-layer precoder selected from the candidate 2Tx four-layer precoders described in the second sub-embodiment of the fourth embodiment are selected. The first and the second precoding vectors (i.e., first column and second column) of the first selected 2Tx four-layer precoder are applied to the antenna ports 0, 4 corresponding to the first antenna group for the first layer and the second layer, the third and the fourth precoding vectors (i.e., third column and fourth column) of the first selected 2Tx four-layer precoder are applied to the antenna ports 1, 5 corresponding to the second antenna group for the third layer and the fourth layer, the first and the second precoding vectors (i.e., first column and second column) of the second selected 2Tx four-layer precoder are applied to the antenna ports 2, 6 corresponding to the third antenna group for the fifth layer and the sixth layer, and the third and the fourth precoding vectors (i.e., third column and fourth column) of the second selected 2Tx four-layer precoder are applied to the antenna ports 3, 7 corresponding to the fourth antenna group for the seventh layer and the eighth layer. The final rank 8 precoding matrix should be normalized so that the power of the precoder is no more than 1

An example of the second sub-embodiment of the fifth embodiment is described as follows: when rank=7 is indicated and

$${W}_{2 Tx , 3} = [ \begin{matrix}1 & 1 & 1 \\ 1 & - 1 & j\end{matrix} ] and {W}_{2 Tx , 4} = [ \begin{matrix}1 & 1 & 1 & 1 \\ 1 & - 1 & j & - j\end{matrix} ]$$

are selected, the first and the second precoding vectors ([1 1]^{T}, [1-1]^{T}) of the selected 2Tx three-layer precoder are applied to the antenna ports 0, 4 corresponding to the first antenna group for the first layer and the second layer, the third precoding vector ([1 j]^{T}) of the selected 2Tx three-layer precoder is applied to the antenna ports 1, 5 corresponding to the second antenna group for the third layer, the first and the second precoding vectors ([1 1]^{T}, [1-1]^{T}) of the selected 2Tx four-layer precoder are applied to the antenna ports 2, 6 corresponding to the third antenna group for the fourth layer and the fifth layer, and the third and the fourth precoding vectors ([1 j]^{T}, [1 −j]^{T}) of the selected 2Tx four-layer precoder are applied to the antenna ports 3, 7 corresponding to the fourth antenna group for the sixth layer and the seventh layer. So, the 8Tx rank 7 precoder is constructed as

$${W}_{8 Tx , 7} = \frac{1}{4} [ \begin{matrix}1 & 1 & 0 & 0 & 0 & 0 & 0 \\ 0 & 0 & 1 & 0 & 0 & 0 & 0 \\ 0 & 0 & 0 & 1 & 1 & 0 & 0 \\ 0 & 0 & 0 & 0 & 0 & 1 & 1 \\ 1 & - 1 & 0 & 0 & 0 & 0 & 0 \\ 0 & 0 & j & 0 & 0 & 0 & 0 \\ 0 & 0 & 0 & 1 & - 1 & 0 & 0 \\ 0 & 0 & 0 & 0 & 0 & j & - j\end{matrix} ] .$$

A sixth embodiment relates to TPMI indication.

The precoding matrix, i.e., the precoder, should be indicated to the UE in the DCI scheduling a PUSCH transmission. In NR Release 17, the transmit rank index (TRI) and the transmit precoding matrix index (TPMI) are jointly indicated by a Precoding information and number of layers field (totally 62 precoders for 4Tx UE with max rank 4 transmission) of the scheduling DCI. For 8Tx UE, the available precoding matrices are much larger. In view of the above, this disclosure proposes to contain separate TRI field and TPMI field in the scheduling DCI. Considering that the transmission rank is exactly the same as the number of DMRS ports, which are used for channel estimation, for the scheduled PUSCH transmission. The transmission rank can be implicitly determined by the antenna port(s) field, which is used to indicate the DMRS port(s) for the scheduled PUSCH transmission with DMRS indication table. It means that TRI field is unnecessary. The TPMI field only needs to indicate the precoding matrix corresponding to each rank.

Based on the codebook structure discussed in the first to the fifth embodiments, a summary of for the TPMI indication is summarized as follows:

For the partial coherent UE with Ng=2, 4Tx TPMI will have the bitwidth determined by the maximum number of precoders corresponding to each supported rank for dynamic rank indication.

The required number of bits for the TPMI field for each of rank 1, rank 2, rank 3, rank 4, rank 5, rank 6, rank 7 and rank 8 for partial coherent UE with Ng=2 are summarized as follows:

For rank 1, 1 bit (antenna group select indicator to indicate one of the first antenna group and the second antenna group)+5 bits (4Tx single-layer TPMI indicator from Table 6.3.1.5-2 for DFT-s-OFDM waveform or from Table 6.3.1.5-3 for CP-OFDM waveform)=6 bits.

For rank 2, 5 bits (4Tx two-layer TPMI indicator from Table 6.3.1.5-5).

For rank 3, 3 bits (4Tx three-layer TPMI indicator from Table 6.3.1.5-6).

For rank 4, 3 bits (4Tx four-layer TPMI indicator from Table 6.3.1.5-7).

For rank 5, 5 bits (4Tx two-layer TPMI indicator from Table 6.3.1.5-5)+3 bits (4Tx layer three-layer TPMI indicator from Table 6.3.1.5-6)=8 bits.

For rank 6, 3 bits (4Tx layer three-layer TPMI indicator from Table 6.3.1.5-6)+3 bits (4Tx layer three-layer TPMI indicator from Table 6.3.1.5-6)=6 bits.

For rank 7, 3 bits (4Tx layer three-layer TPMI indicator from Table 6.3.1.5-6)+3 bits (4Tx four-layer TPMI indicator from Table 6.3.1.5-7)=6 bits.

For rank 8, 3 bits (4Tx four-layer TPMI indicator from Table 6.3.1.5-7)+3 bits (4Tx four-layer TPMI indicator from Table 6.3.1.5-7)=6 bits.

Different values of maxRank (i.e., the supported maximum rank) correspond to different UE capabilities. For example, the values of maxRank can be reported by the UE as 1 or 4 or 8. The TPMI field bitwidth shall be determined separately for maxRank=4 and maxRank=8, respectively.

Based on the disclosed codebook structure, for the partial coherent UE with Ng=2 with maximum rank <=4 (e.g., maxRank=1, 2, 3 or 4), the bitwidth of the TPMI field can be 6 bits since the maximum required bitwidth is 6 bits (i.e., for rank=1) for rank <=4, while for the partial coherent UE with Ng=2 with maximum Rank >4 (e.g., maxRank=5, 6, 7 or 8), the bitwidth of the TPMI field can be 8 bits since the maximum required bitwidth is 8 bits (i.e., for rank=5) for rank >4.

For the partial coherent UE with Ng=4, 2Tx TPMI will have the bitwidth determined by the maximum number of precoders corresponding to each supported rank for dynamic rank indication.

The required number of bits for the TPMI field for each of rank 1, rank 2, rank 3, rank 4, rank 5, rank 6, rank 7 and rank 8 for partial coherent UE with Ng=4 are summarized as follows:

For rank 1, 2 bits (antenna group select indicator to indicate one of the first antenna group, the second antenna group, the third antenna group and the fourth antenna group) +3 bits (2Tx single-layer TPMI indicator to indicate one of 6 candidate 2Tx single-layer precoders described in step 122)=5 bits.

For rank 2, 3 bits (antenna group select indicator to indicate 6 candidate 2 antenna groups described in step 221)+3 bits (2Tx two-layer TPMI indicator to indicate one of 5 candidate 2Tx two-layer precoders described in step 222)=6 bits.

For rank 3, 2 bits (antenna group select indicator to indicate 4 candidate 3 antenna groups described in step 321)+3 bits (2Tx three-layer TPMI indicator to indicate one of 7 candidate 2Tx three-layer precoders described in step 322)=5 bits.

For rank 4, 2 bits (2Tx four-layer TPMI indicator to indicate one of 4 candidate 2Tx four-layer precoders described in step 422).

For rank 5, 3 bits (2Tx two-layer TPMI indicator)+3 bits (2Tx three-layer TPMI indicator)=6 bits.

For rank 6, 3 bits (2Tx three-layer TPMI indicator)+3 bits (2Tx three-layer TPMI indicator)=6 bits.

For rank 7, 3 bits (2Tx three-layer TPMI indicator)+2 bits (2Tx four-layer TPMI indicator)=5 bits.

For rank 8, 2 bits (2Tx four-layer TPMI indicator)+2 bits (2Tx four-layer TPMI indicator)=4 bits.

Based on the disclosed codebook structure, for the partial coherent UE with Ng=4 with maximum rank=1, the bitwidth of the TPMI field can be 5 bits, while for the partial coherent UE with Ng=4 with maximum rank >1 (e.g., maxRank=2, 3, 4, 5, 6, 7 or 8), the bitwidth of the TPMI field can be 6 bits since the maximum required bitwidth is 6 bits (i.e., for rank=2 and rank=5 and rank=6) for rank >1.

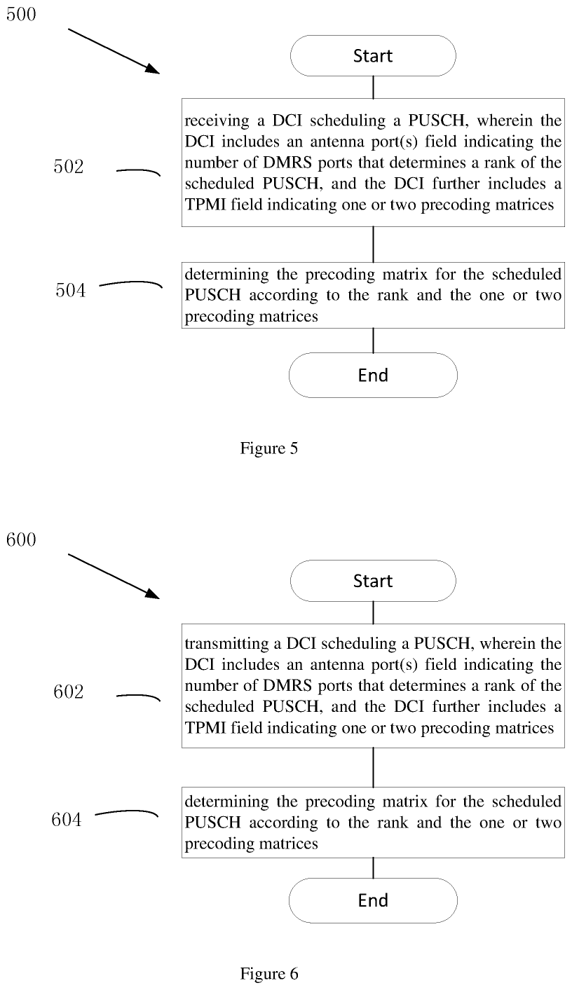

FIG. 5 is a schematic flow chart diagram illustrating an embodiment of a method 500 according to the present application. In some embodiments, the method 500 is performed by an apparatus, such as a remote unit (e.g., UE). In certain embodiments, the method 500 may be performed by a processor executing program code, for example, a microcontroller, a microprocessor, a CPU, a GPU, an auxiliary processing unit, a FPGA, or the like.

The method 500 is a method performed at a UE, comprising: 502 receiving a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and 504 determining the precoding matrix for the scheduled PUSCH according to the rank and the one or two precoding matrices.

In some embodiment, the method further comprises reporting the number of antenna groups (Ng).

In some embodiment, the method further comprises determining the bitwidth of the TPMI field according to a maximum rank with value of 1, 4 or 8.

In some embodiment, when a rank 1, rank 2, or rank 3 PUSCH is scheduled for UE with Ng=4, the TPMI field indicates the antenna group, by the antenna ports from which each PUSCH layer is transmitted.

In some embodiment, when a rank 4, rank 5, rank 6, rank 7 or rank 8 PUSCH is scheduled for UE with Ng=4, each PUSCH layer being transmitted by antenna ports from which antenna group is predetermined. In particular, when a rank 4 PUSCH is scheduled for UE with Ng=4, a first PUSCH layer is transmitted by antenna ports from a first antenna group, a second PUSCH layer is transmitted by antenna ports from a second antenna group, a third PUSCH layer is transmitted by antenna ports from a third antenna group, and a fourth PUSCH layer is transmitted by antenna ports from a fourth antenna group; when a rank 5 PUSCH is scheduled for UE with Ng=4, a first PUSCH layer is transmitted by antenna ports from the first antenna group, a second PUSCH layer is transmitted by antenna ports from the second antenna group, a third PUSCH layer and a fourth PUSCH layer are transmitted by antenna ports from the third antenna group, and a fifth PUSCH layer is transmitted by antenna ports from the fourth antenna group; when a rank 6 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer is transmitted by antenna ports from the fourth antenna group; when a rank 7 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer and a seventh PUSCH layer are transmitted by antenna ports from the fourth antenna group; and when a rank 8 PUSCH is scheduled for UE with Ng=4, a first PUSCH layer and a second PUSCH layer are transmitted by antenna ports from the first antenna group, a third PUSCH layer and a fourth PUSCH layer are transmitted by antenna ports from the second antenna group, a fifth PUSCH layer and a sixth PUSCH layer are transmitted by antenna ports from the third antenna group, and a seventh PUSCH layer and an eighth PUSCH layer are transmitted by antenna ports from the fourth antenna group.

In some embodiment, when a rank 1 PUSCH is scheduled for UE with Ng=2, the TPMI field indicates the antenna group, by the antenna ports from which a single PUSCH layer is transmitted.

In some embodiment, when a rank 2, rank 3, rank 4, rank 5, rank 6, rank 7 or rank 8 PUSCH is scheduled for UE with Ng=2, each PUSCH layer being transmitted by antenna ports from which antenna group is predetermined. In particular, when a rank 2 PUSCH is scheduled for UE with Ng=2, a first PUSCH layer is transmitted by antenna ports from a first antenna group, and a second PUSCH layer is transmitted by antenna ports from a second antenna group; when a rank 3 PUSCH is scheduled for UE with Ng=2, a first PUSCH layer is transmitted by antenna ports from the first antenna group, and a second PUSCH layer and a third PUSCH layer are transmitted by antenna ports from the second antenna group; when a rank 4 PUSCH is scheduled for UE with Ng=2, a first PUSCH layer and a second PUSCH layer are transmitted by antenna ports from the first antenna group, and a third PUSCH layer and a fourth PUSCH layer are transmitted by antenna ports from the second antenna group; when a rank 5 PUSCH is scheduled for UE with Ng=2, a first PUSCH layer and a second PUSCH layer are transmitted by antenna ports from the first antenna group, and a third PUSCH layer, a fourth PUSCH layer and a fifth PUSCH layer are transmitted by antenna ports from the second antenna group; when a rank 6 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer and a sixth PUSCH layer are transmitted by antenna ports from the second antenna group; when a rank 7 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer, a sixth PUSCH layer and a seventh PUSCH layer are transmitted by antenna ports from the second antenna group; and when a rank 8 PUSCH is scheduled for UE with Ng=2, a first PUSCH layer, a second PUSCH layer, a third PUSCH layer and a fourth PUSCH layer are transmitted by antenna ports from the first antenna group, and a fifth PUSCH layer, a sixth PUSCH layer, a seventh PUSCH layer and an eighth PUSCH layer are transmitted by antenna ports from the second antenna group.

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may comprise 602 transmitting a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and 604 determining the precoding matrix for the scheduled PUSCH according to the rank and the one or two precoding matrices.

In some embodiment, the method further comprises receiving the number of antenna groups (Ng).

In some embodiment, the method further comprises determining the bitwidth of the TPMI field according to a maximum rank with value of 1, 4 or 8.

In some embodiment, when a rank 1, rank 2, or rank 3 PUSCH is scheduled for UE with Ng=4, the TPMI field indicates the antenna group, by the antenna ports from which each PUSCH layer is transmitted.

In some embodiment, when a rank 4, rank 5, rank 6, rank 7 or rank 8 PUSCH is scheduled for UE with Ng=4, each PUSCH layer being transmitted by antenna ports from which antenna group is predetermined. In particular, when a rank 4 PUSCH is scheduled for UE with Ng=4, a first PUSCH layer is transmitted by antenna ports from a first antenna group, a second PUSCH layer is transmitted by antenna ports from a second antenna group, a third PUSCH layer is transmitted by antenna ports from a third antenna group, and a fourth PUSCH layer is transmitted by antenna ports from a fourth antenna group; when a rank 5 PUSCH is scheduled for UE with Ng=4, a first PUSCH layer is transmitted by antenna ports from the first antenna group, a second PUSCH layer is transmitted by antenna ports from the second antenna group, a third PUSCH layer and a fourth PUSCH layer are transmitted by antenna ports from the third antenna group, and a fifth PUSCH layer is transmitted by antenna ports from the fourth antenna group; when a rank 6 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer is transmitted by antenna ports from the fourth antenna group; when a rank 7 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer and a seventh PUSCH layer are transmitted by antenna ports from the fourth antenna group; and when a rank 8 PUSCH is scheduled for UE with Ng=4, a first PUSCH layer and a second PUSCH layer are transmitted by antenna ports from the first antenna group, a third PUSCH layer and a fourth PUSCH layer are transmitted by antenna ports from the second antenna group, a fifth PUSCH layer and a sixth PUSCH layer are transmitted by antenna ports from the third antenna group, and a seventh PUSCH layer and an eighth PUSCH layer are transmitted by antenna ports from the fourth antenna group.

In some embodiment, when a rank 1 PUSCH is scheduled for UE with Ng=2, the TPMI field indicates the antenna group, by the antenna ports from which a single PUSCH layer is transmitted.

In some embodiment, when a rank 2, rank 3, rank 4, rank 5, rank 6, rank 7 or rank 8 PUSCH is scheduled for UE with Ng=2, each PUSCH layer being transmitted by antenna ports from which antenna group is predetermined. In particular, when a rank 2 PUSCH is scheduled for UE with Ng=2, a first PUSCH layer is transmitted by antenna ports from a first antenna group, and a second PUSCH layer is transmitted by antenna ports from a second antenna group; when a rank 3 PUSCH is scheduled for UE with Ng=2, a first PUSCH layer is transmitted by antenna ports from the first antenna group, and a second PUSCH layer and a third PUSCH layer are transmitted by antenna ports from the second antenna group; when a rank 4 PUSCH is scheduled for UE with Ng=2, a first PUSCH layer and a second PUSCH layer are transmitted by antenna ports from the first antenna group, and a third PUSCH layer and a fourth PUSCH layer are transmitted by antenna ports from the second antenna group; when a rank 5 PUSCH is scheduled for UE with Ng=2, a first PUSCH layer and a second PUSCH layer are transmitted by antenna ports from the first antenna group, and a third PUSCH layer, a fourth PUSCH layer and a fifth PUSCH layer are transmitted by antenna ports from the second antenna group; when a rank 6 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer and a sixth PUSCH layer are transmitted by antenna ports from the second antenna group; when a rank 7 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer, a sixth PUSCH layer and a seventh PUSCH layer are transmitted by antenna ports from the second antenna group; and when a rank 8 PUSCH is scheduled for UE with Ng=2, a first PUSCH layer, a second PUSCH layer, a third PUSCH layer and a fourth PUSCH layer are transmitted by antenna ports from the first antenna group, and a fifth PUSCH layer, a sixth PUSCH layer, a seventh PUSCH layer and an eighth PUSCH layer are transmitted by antenna ports from the second antenna group.

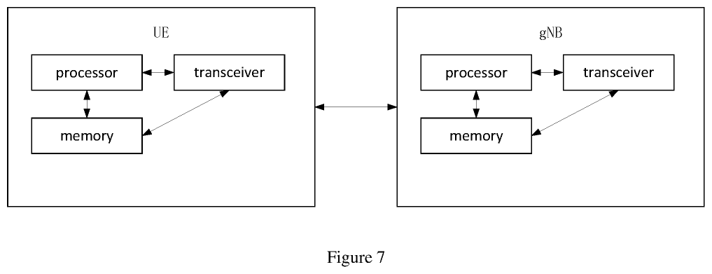

FIG. 7 is a schematic block diagram illustrating apparatuses according to one embodiment.

Referring to FIG. 7, the UE (i.e., the remote unit) includes a processor, a memory, and a transceiver. The processor implements a function, a process, and/or a method which are proposed in FIG. 5.

The UE comprises a transceiver; and a processor coupled to the transceiver, wherein the processor is configured to receive, via the transceiver, a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determine the precoding matrix for the scheduled PUSCH according to the rank and the one or two precoding matrices.

In some embodiment, the processor is further configured to report, via the transceiver, the number of antenna groups (Ng).

In some embodiment, the processor is further configured to determine the bitwidth of the TPMI field according to a maximum rank with value of 1, 4 or 8.

In some embodiment, when a rank 1, rank 2, or rank 3 PUSCH is scheduled for UE with Ng=4, the TPMI field indicates the antenna group, by the antenna ports from which each PUSCH layer is transmitted.

In some embodiment, when a rank 4, rank 5, rank 6, rank 7 or rank 8 PUSCH is scheduled for UE with Ng=4, each PUSCH layer being transmitted by antenna ports from which antenna group is predetermined. In particular, when a rank 4 PUSCH is scheduled for UE with Ng=4, a first PUSCH layer is transmitted by antenna ports from a first antenna group, a second PUSCH layer is transmitted by antenna ports from a second antenna group, a third PUSCH layer is transmitted by antenna ports from a third antenna group, and a fourth PUSCH layer is transmitted by antenna ports from a fourth antenna group; when a rank 5 PUSCH is scheduled for UE with Ng=4, a first PUSCH layer is transmitted by antenna ports from the first antenna group, a second PUSCH layer is transmitted by antenna ports from the second antenna group, a third PUSCH layer and a fourth PUSCH layer are transmitted by antenna ports from the third antenna group, and a fifth PUSCH layer is transmitted by antenna ports from the fourth antenna group; when a rank 6 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer is transmitted by antenna ports from the fourth antenna group; when a rank 7 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer and a seventh PUSCH layer are transmitted by antenna ports from the fourth antenna group; and when a rank 8 PUSCH is scheduled for UE with Ng=4, a first PUSCH layer and a second PUSCH layer are transmitted by antenna ports from the first antenna group, a third PUSCH layer and a fourth PUSCH layer are transmitted by antenna ports from the second antenna group, a fifth PUSCH layer and a sixth PUSCH layer are transmitted by antenna ports from the third antenna group, and a seventh PUSCH layer and an eighth PUSCH layer are transmitted by antenna ports from the fourth antenna group.

In some embodiment, when a rank 1 PUSCH is scheduled for UE with Ng=2, the TPMI field indicates the antenna group, by the antenna ports from which a single PUSCH layer is transmitted.

In some embodiment, when a rank 2, rank 3, rank 4, rank 5, rank 6, rank 7 or rank 8 PUSCH is scheduled for UE with Ng=2, each PUSCH layer being transmitted by antenna ports from which antenna group is predetermined. In particular, when a rank 2 PUSCH is scheduled for UE with Ng=2, a first PUSCH layer is transmitted by antenna ports from a first antenna group, and a second PUSCH layer is transmitted by antenna ports from a second antenna group; when a rank 3 PUSCH is scheduled for UE with Ng=2, a first PUSCH layer is transmitted by antenna ports from the first antenna group, and a second PUSCH layer and a third PUSCH layer are transmitted by antenna ports from the second antenna group; when a rank 4 PUSCH is scheduled for UE with Ng=2, a first PUSCH layer and a second PUSCH layer are transmitted by antenna ports from the first antenna group, and a third PUSCH layer and a fourth PUSCH layer are transmitted by antenna ports from the second antenna group; when a rank 5 PUSCH is scheduled for UE with Ng=2, a first PUSCH layer and a second PUSCH layer are transmitted by antenna ports from the first antenna group, and a third PUSCH layer, a fourth PUSCH layer and a fifth PUSCH layer are transmitted by antenna ports from the second antenna group; when a rank 6 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer and a sixth PUSCH layer are transmitted by antenna ports from the second antenna group; when a rank 7 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer, a sixth PUSCH layer and a seventh PUSCH layer are transmitted by antenna ports from the second antenna group; and when a rank 8 PUSCH is scheduled for UE with Ng=2, a first PUSCH layer, a second PUSCH layer, a third PUSCH layer and a fourth PUSCH layer are transmitted by antenna ports from the first antenna group, and a fifth PUSCH layer, a sixth PUSCH layer, a seventh PUSCH layer and an eighth PUSCH layer are transmitted by antenna ports from the second antenna group.

The gNB (i.e., the base unit) includes a processor, a memory, and a transceiver. The processor implements a function, a process, and/or a method which are proposed in FIG. 6.

The base unit comprises a transceiver; and a processor coupled to the transceiver, wherein the processor is configured to transmit, via the transceiver, a DCI scheduling a PUSCH, wherein the DCI includes an antenna port(s) field indicating the number of DMRS ports that determines a rank of the scheduled PUSCH, and the DCI further includes a TPMI field indicating one or two precoding matrices; and determine the precoding matrix for the scheduled PUSCH according to the rank and the one or two precoding matrices.

In some embodiment, the processor is further configured to receive, via the transceiver, the number of antenna groups (Ng).

In some embodiment, the processor is further configured to determine the bitwidth of the TPMI field according to a maximum rank with value of 1, 4 or 8.

In some embodiment, when a rank 1, rank 2, or rank 3 PUSCH is scheduled for UE with Ng=4, the TPMI field indicates the antenna group, by the antenna ports from which each PUSCH layer is transmitted.

In some embodiment, when a rank 4, rank 5, rank 6, rank 7 or rank 8 PUSCH is scheduled for UE with Ng=4, each PUSCH layer being transmitted by antenna ports from which antenna group is predetermined. In particular, when a rank 4 PUSCH is scheduled for UE with Ng=4, a first PUSCH layer is transmitted by antenna ports from a first antenna group, a second PUSCH layer is transmitted by antenna ports from a second antenna group, a third PUSCH layer is transmitted by antenna ports from a third antenna group, and a fourth PUSCH layer is transmitted by antenna ports from a fourth antenna group; when a rank 5 PUSCH is scheduled for UE with Ng=4, a first PUSCH layer is transmitted by antenna ports from the first antenna group, a second PUSCH layer is transmitted by antenna ports from the second antenna group, a third PUSCH layer and a fourth PUSCH layer are transmitted by antenna ports from the third antenna group, and a fifth PUSCH layer is transmitted by antenna ports from the fourth antenna group; when a rank 6 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer is transmitted by antenna ports from the fourth antenna group; when a rank 7 PUSCH is scheduled for UE with Ng=4, a first PUSCH layer and a second PUSCH layer are transmitted by antenna ports from the first antenna group, a third PUSCH layer is transmitted by antenna ports from the second antenna group, a fourth PUSCH layer and a fifth PUSCH layer are transmitted by antenna ports from the third antenna group, and a sixth PUSCH layer and a seventh PUSCH layer are transmitted by antenna ports from the fourth antenna group; and when a rank 8 PUSCH is scheduled for UE with Ng=4, a first PUSCH layer and a second PUSCH layer are transmitted by antenna ports from the first antenna group, a third PUSCH layer and a fourth PUSCH layer are transmitted by antenna ports from the second antenna group, a fifth PUSCH layer and a sixth PUSCH layer are transmitted by antenna ports from the third antenna group, and a seventh PUSCH layer and an eighth PUSCH layer are transmitted by antenna ports from the fourth antenna group.

In some embodiment, when a rank 1 PUSCH is scheduled for UE with Ng=2, the TPMI field indicates the antenna group, by the antenna ports from which a single PUSCH layer is transmitted.

In some embodiment, when a rank 2, rank 3, rank 4, rank 5, rank 6, rank 7 or rank 8 PUSCH is scheduled for UE with Ng=2, each PUSCH layer being transmitted by antenna ports from which antenna group is predetermined. In particular, when a rank 2 PUSCH is scheduled for UE with Ng=2, a first PUSCH layer is transmitted by antenna ports from a first antenna group, and a second PUSCH layer is transmitted by antenna ports from a second antenna group; when a rank 3 PUSCH is scheduled for UE with Ng=2, a first PUSCH layer is transmitted by antenna ports from the first antenna group, and a second PUSCH layer and a third PUSCH layer are transmitted by antenna ports from the second antenna group; when a rank 4 PUSCH is scheduled for UE with Ng=2, a first PUSCH layer and a second PUSCH layer are transmitted by antenna ports from the first antenna group, and a third PUSCH layer and a fourth PUSCH layer are transmitted by antenna ports from the second antenna group; when a rank 5 PUSCH is scheduled for UE with Ng=2, a first PUSCH layer and a second PUSCH layer are transmitted by antenna ports from the first antenna group, and a third PUSCH layer, a fourth PUSCH layer and a fifth PUSCH layer are transmitted by antenna ports from the second antenna group; when a rank 6 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer and a sixth PUSCH layer are transmitted by antenna ports from the second antenna group; when a rank 7 PUSCH is scheduled for UE with Ng=2, a first PUSCH layer, a second PUSCH layer and a third PUSCH layer are transmitted by antenna ports from the first antenna group, and a fourth PUSCH layer, a fifth PUSCH layer, a sixth PUSCH layer and a seventh PUSCH layer are transmitted by antenna ports from the second antenna group; and when a rank 8 PUSCH is scheduled for UE with Ng=2, a first PUSCH layer, a second PUSCH layer, a third PUSCH layer and a fourth PUSCH layer are transmitted by antenna ports from the first antenna group, and a fifth PUSCH layer, a sixth PUSCH layer, a seventh PUSCH layer and an eighth PUSCH layer are transmitted by antenna ports from the second antenna group.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive downlink control information (DCI) scheduling a physical uplink shared channel (PUSCH), wherein the PUSCH is transmitted over eight antenna ports of antenna groups based at least in part on one or more of:
if a rank 7 PUSCH is scheduled for the UE with four antenna groups, then a first PUSCH layer and a second PUSCH layer are transmitted by the antenna ports of a first antenna group, a third PUSCH layer is transmitted by the antenna ports of a second antenna group, a fourth PUSCH layer and a fifth PUSCH layer are transmitted by the antenna ports of a third antenna group, and a sixth PUSCH layer and a seventh PUSCH layer are transmitted by the antenna ports of a fourth antenna group;
if a rank 8 PUSCH is scheduled for the UE with the four antenna groups, then the first PUSCH layer and the second PUSCH layer are transmitted by the antenna ports of the first antenna group, the third PUSCH layer and the fourth PUSCH layer are transmitted by the antenna ports of the second antenna group, the fifth PUSCH layer and the sixth PUSCH layer are transmitted by the ports of the third antenna group, and the seventh PUSCH layer and an eighth PUSCH layer are transmitted by the antenna ports of the fourth antenna group;
if a rank 5 PUSCH is scheduled for the UE with two antenna groups, then the first PUSCH layer and the second PUSCH layer are transmitted by the antenna ports of the first antenna group, and the third PUSCH layer, the fourth PUSCH layer, and the fifth PUSCH layer are transmitted by the antenna ports of the second antenna group:
if a rank 6 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, and the sixth PUSCH layer are transmitted by the antenna ports of the second antenna group;
if the rank 7 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, the sixth PUSCH layer, and the seventh PUSCH layer are transmitted by the antenna ports of the second antenna group; or
if the rank 8 PUSCH is scheduled for the UE with the two antenna groups, then the first PUSCH layer, the second PUSCH layer, the third PUSCH layer, and the fourth PUSCH layer are transmitted by the antenna ports from the first antenna group, and the fifth PUSCH layer, the sixth PUSCH layer, the seventh PUSCH layer, and the eighth PUSCH layer are transmitted by the antenna ports from the second antenna group.

2. The UE of claim 1, wherein the at least one processor is further configured to cause the UE to report a number of the antenna groups.

3. The UE of claim 1, wherein the at least one processor is further configured to cause the UE to determine a bitwidth of a transmit precoding matrix indicator (TPMI) field according to a maximum rank with a value of 1, 4 or 8.

4. The UE of claim 1, wherein, if a rank 1, rank 2, or rank 3 PUSCH is scheduled for the UE with the four antenna groups, then a transmit precoding matrix indicator (TPMI) field indicates the antenna group, by the antenna ports from which each PUSCH layer is transmitted.

5. The UE of claim 1, wherein, if a rank 4, rank 5, rank 6, rank 7 or rank 8 PUSCH is scheduled for the UE with the four antenna groups, each PUSCH layer is transmitted by the antenna ports from which the antenna group is predetermined.

6. The UE of claim 5, wherein:
if a rank 4 PUSCH is scheduled for the UE with the four antenna groups, then the first PUSCH layer is transmitted by the antenna ports of the first antenna group, the second PUSCH layer is transmitted by the antenna ports of the second antenna group, the third PUSCH layer is transmitted by the antenna ports of the third antenna group, and the fourth PUSCH layer is transmitted by the antenna ports of the fourth antenna group;
if the rank 5 PUSCH is scheduled for the UE with the four antenna groups, then the first PUSCH layer is transmitted by the antenna ports of the first antenna group, the second PUSCH layer is transmitted by the antenna ports of the second antenna group, the third PUSCH layer and the fourth PUSCH layer are transmitted by the antenna ports of the third antenna group, and the fifth PUSCH layer is transmitted by the antenna ports of the fourth antenna group; and
if the rank 6 PUSCH is scheduled for the UE with the four antenna groups, then the first PUSCH layer and the second PUSCH layer are transmitted by the antenna ports of the first antenna group, the third PUSCH layer is transmitted by the antenna ports of the second antenna group, the fourth PUSCH layer and the fifth PUSCH layer are transmitted by the antenna ports of the third antenna group, and the sixth PUSCH layer is transmitted by the antenna ports of the fourth antenna group.

7. The UE of claim 1, wherein, if a rank 1 PUSCH is scheduled for the UE with the two antenna groups, then a transmit precoding matrix indicator (TPMI) field indicates the antenna group, by the antenna ports from which a single PUSCH layer is transmitted.

8. The UE of claim 1, wherein, if a rank 2, rank 3, rank 4, rank 5, rank 6, rank [7]7 or rank 8 PUSCH is scheduled for the UE with the two antenna groups, each PUSCH layer is transmitted by the antenna ports from which the antenna group is predetermined.

9. The UE of claim 8, wherein:
if the rank 2 PUSCH is scheduled for the UE with the two antenna groups, the first PUSCH layer is transmitted by the antenna ports of the first antenna group, and the second PUSCH layer is transmitted by the antenna ports of the second antenna group;
if the rank 3 PUSCH is scheduled for the UE with the two antenna groups, the first PUSCH layer is transmitted by the antenna ports of the first antenna group, and the second PUSCH layer and the third PUSCH layer are transmitted by the antenna ports of the second antenna group; and
if the rank 4 PUSCH is scheduled for the UE with the two antenna groups, the first PUSCH layer and the second PUSCH layer are transmitted by the antenna ports of the first antenna group, and the third PUSCH layer and the fourth PUSCH layer are transmitted by the antenna ports of the second antenna group.

10. (canceled)

11. A base unit for wireless communication, comprising:
at least one memory; and
at least one processor coupled with the at least one memory and configured to cause the base unit to:
transmit downlink control information (DCI) scheduling a physical uplink shared channel (PUSCH), wherein the PUSCH is configured for transmission over eight antenna ports of antenna groups based at least in part on one or more of:
if a rank 7 PUSCH is scheduled for a user equipment (UE) with four antenna groups, then a first PUSCH layer and a second PUSCH layer are transmitted by the antenna ports of a first antenna group, a third PUSCH layer is transmitted by the antenna ports of a second antenna group, a fourth PUSCH layer and a fifth PUSCH layer are transmitted by the antenna ports of a third antenna group, and a sixth PUSCH layer and a seventh PUSCH layer are transmitted by the antenna ports of a fourth antenna group;
if a rank 8 PUSCH is scheduled for the UE with the four antenna groups, then the first PUSCH layer and the second PUSCH layer are transmitted by the antenna ports of the first antenna group, the third PUSCH layer and the fourth PUSCH layer are transmitted by the antenna ports of the second antenna group the fifth PUSCH layer and the sixth PUSCH layer are transmitted by the ports of the third antenna group, and the seventh PUSCH layer and an eighth PUSCH layer are transmitted by the antenna ports of the fourth antenna group;
if a rank 5 PUSCH is scheduled for the UE with two antenna groups, then the first PUSCH layer and the second PUSCH layer are transmitted by the antenna ports of the first antenna group, and the third PUSCH layer, the fourth PUSCH layer, and the fifth PUSCH layer are transmitted by the antenna ports of the second antenna group;
if a rank 6 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, and the sixth PUSCH layer are transmitted by the antenna ports of the second antenna group;
if the rank 7 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, the sixth PUSCH layer and the seventh PUSCH layer are transmitted by the antenna ports of the second antenna group; or
if the rank 8 PUSCH is scheduled for the UE with the two antenna groups, then the first PUSCH layer, the second PUSCH layer, the third PUSCH layer, and the fourth PUSCH layer are transmitted by the antenna ports from the first antenna group, and the fifth PUSCH layer, the sixth PUSCH layer, the seventh PUSCH layer, and the eighth PUSCH layer are transmitted by the antenna ports from the second antenna group.

12. A method performed by a base unit, the method comprising:
transmitting downlink control information (DCI) scheduling a physical uplink shared channel (PUSCH), wherein the PUSCH is configured for transmission over eight antenna ports of antenna groups based at least in part on one or more of:
if a rank 7 PUSCH is scheduled for a user equipment (UE) with four antenna groups, then a first PUSCH layer and a second PUSCH layer are transmitted by the antenna ports of a first antenna group, a third PUSCH layer is transmitted by the antenna ports of a second antenna group, a fourth PUSCH layer and a fifth PUSCH layer are transmitted by the antenna ports of a third antenna group, and a sixth PUSCH layer and a seventh PUSCH layer are transmitted by the antenna ports of a fourth antenna group;
if a rank 8 PUSCH is scheduled for the UE with the four antenna groups, then the first PUSCH layer and the second PUSCH layer are transmitted by the antenna ports of the first antenna group, the third PUSCH layer and the fourth PUSCH layer are transmitted by the antenna ports of the second antenna group, the fifth PUSCH layer and the sixth PUSCH layer are transmitted by the ports of the third antenna group, and the seventh PUSCH layer and an eighth PUSCH layer are transmitted by the antenna ports of the fourth antenna group;
if a rank 5 PUSCH is scheduled for the UE with two antenna groups, then the first PUSCH layer and the second PUSCH layer are transmitted by the antenna ports of the first antenna group, and the third PUSCH layer, the fourth PUSCH layer, and the fifth PUSCH layer are transmitted by the antenna ports of the second antenna group;
if a rank 6 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, and the sixth PUSCH layer are transmitted by the antenna ports of the second antenna group;
if the rank 7 PUSCH is scheduled for the UE with the two antenna groups, then the first PUSCH layer, the second PUSCH layer, and the third PUSCH layer are transmitted by the antenna ports of the first antenna group, and the fourth PUSCH layer, the fifth PUSCH layer, the sixth PUSCH layer, and the seventh PUSCH layer are transmitted by the antenna ports of the second antenna group; or
if the rank 8 PUSCH is scheduled for the UE with the two antenna groups, then the first PUSCH layer, the second PUSCH layer, the third PUSCH layer, and the fourth PUSCH layer are transmitted by the antenna ports from the first antenna group, and the fifth PUSCH layer, the sixth PUSCH layer, the seventh PUSCH layer, and the eighth PUSCH layer are transmitted by the antenna ports from the second antenna group.

13. A method performed by a user equipment (UE), the method comprising:
receiving downlink control information (DCI) scheduling a physical uplink shared channel (PUSCH), wherein the PUSCH is transmitted over eight antenna ports of antenna groups based at least in part on one or more of:
if a rank 7 PUSCH is scheduled for the UE with four antenna groups, then transmitting a first PUSCH layer and a second PUSCH layer by the antenna ports of a first antenna group, transmitting a third PUSCH layer by the antenna ports of a second antenna group, transmitting a fourth PUSCH layer and a fifth PUSCH layer by the antenna ports of a third antenna group, and transmitting a sixth PUSCH layer and a seventh PUSCH layer by the antenna ports of a fourth antenna group;
if a rank 8 PUSCH is scheduled for the UE with the four antenna groups, then transmitting the first PUSCH layer and the second PUSCH layer by the antenna ports of the first antenna group, transmitting the third PUSCH layer and the fourth PUSCH layer by the antenna ports of the second antenna group, transmitting the fifth PUSCH layer and the sixth PUSCH layer by the ports of the third antenna group, and transmitting the seventh PUSCH layer and an eighth PUSCH layer by the antenna ports of the fourth antenna group;
if a rank 5 PUSCH is scheduled for the UE with two antenna groups, then transmitting the first PUSCH layer and the second PUSCH layer by the antenna ports of the first antenna group, and transmitting the third PUSCH layer, the fourth PUSCH layer, and the fifth PUSCH layer by the antenna ports of the second antenna group;
if a rank 6 PUSCH is scheduled for the UE with the two antenna groups, then transmitting the first PUSCH layer, the second PUSCH layer, and the third PUSCH layer by the antenna ports of the first antenna group, and transmitting the fourth PUSCH layer, the fifth PUSCH layer, and the sixth PUSCH layer by the antenna ports of the second antenna group;
if the rank 7 PUSCH is scheduled for the UE with the two antenna groups, then transmitting the first PUSCH layer, the second PUSCH layer, and the third PUSCH layer by the antenna ports of the first antenna group, and transmitting the fourth PUSCH layer, the fifth PUSCH layer, the sixth PUSCH layer, and the seventh PUSCH layer by the antenna ports of the second antenna group; or
if the rank 8 PUSCH is scheduled for the UE with the two antenna groups, then transmitting the first PUSCH layer, the second PUSCH layer, the third PUSCH layer, and the fourth PUSCH layer by the antenna ports from the first antenna group, and transmitting the fifth PUSCH layer, the sixth PUSCH layer, the seventh PUSCH layer, and the eighth PUSCH layer by the antenna ports from the second antenna group.

14. The method of claim 13, further comprising reporting a number of the antenna groups.

15. The method of claim 13, determining a bitwidth of a transmit precoding matrix indicator (TPMI) field according to a maximum rank with a value of 1, 4, or 8.

16. The method of claim 13, wherein, if a rank 1, rank 2, or rank 3 PUSCH is scheduled for the UE with the four antenna groups, then a transmit precoding matrix indicator (TPMI) field indicates the antenna group, by the antenna ports from which each PUSCH layer is transmitted.

17. The method of claim 13, wherein, if a rank 4, rank 5, rank 6, rank 7, or rank 8 PUSCH is scheduled for the UE with the four antenna groups, each PUSCH layer is transmitted by the antenna ports from which the antenna group is predetermined.

18. The method of claim 17, wherein:
if a rank 4 PUSCH is scheduled for the UE with the four antenna groups, then transmitting the first PUSCH layer by the antenna ports of the first antenna group, transmitting the second PUSCH layer by the antenna ports of the second antenna group, transmitting the third PUSCH layer by the antenna ports of the third antenna group, and transmitting the fourth PUSCH layer by the antenna ports of the fourth antenna group;
if the rank 5 PUSCH is scheduled for the UE with the four antenna groups, then transmitting the first PUSCH layer by the antenna ports of the first antenna group, transmitting the second PUSCH layer by the antenna ports of the second antenna group, transmitting the third PUSCH layer and the fourth PUSCH layer by the antenna ports of the third antenna group, and transmitting the fifth PUSCH layer by the antenna ports of the fourth antenna group; and
if the rank 6 PUSCH is scheduled for the UE with the four antenna groups, then transmitting the first PUSCH layer and the second PUSCH layer by the antenna ports of the first antenna group, transmitting the third PUSCH layer by the antenna ports of the second antenna group, transmitting the fourth PUSCH layer and the fifth PUSCH layer by the antenna ports of the third antenna group, and transmitting the sixth PUSCH layer by the antenna ports of the fourth antenna group.

19. The method of claim 13, wherein, if a rank 1 PUSCH is scheduled for the UE with the two antenna groups, then a transmit precoding matrix indicator (TPMI) field indicates the antenna group, by the antenna ports from which a single PUSCH layer is transmitted.

20. The method of claim 13, wherein, if a rank 2, rank 3, rank 4, rank 5, rank 6, rank 7, or rank 8 PUSCH is scheduled for the UE with the two antenna groups, transmitting each PUSCH layer by the antenna ports from which the antenna group is predetermined.

21. The method of claim 20, wherein:
if the rank 2 PUSCH is scheduled for the UE with the two antenna groups, transmitting the first PUSCH layer by the antenna ports of the first antenna group, and transmitting the second PUSCH layer by the antenna ports of the second antenna group;
if the rank 3 PUSCH is scheduled for the UE with the two antenna groups, transmitting the first PUSCH layer by the antenna ports of the first antenna group, and transmitting the second PUSCH layer and the third PUSCH layer by the antenna ports of the second antenna group; and
if the rank 4 PUSCH is scheduled for the UE with the two antenna groups, transmitting the first PUSCH layer and the second PUSCH layer by the antenna ports of the first antenna group, and transmitting the third PUSCH layer and the fourth PUSCH layer by the antenna ports of the second antenna group.
